(19) United States
(12) Patent Application Publication
(10) Pub. No.: US 2024/0399545 A1
(43) Pub. Date: Dec. 5, 2024

(54) RATCHET TOOL AND RATCHET ASSEMBLY THEREFOR

(71) Applicant: MILWAUKEE ELECTRIC TOOL CORPORATION, Brookfield, WI (US)

(72) Inventors: Evan Brown, Milwaukee, WI (US); Jordan P. Gilsinger, Sussex, WI (US); Fanbin Zeng, Dongguan City (CN); Jian Huang, Dongguan City (CN); Hong Feng Liu, Dongguan City (CN); Zipei Zhang, Dongguan City (CN)

(21) Appl. No.: 18/734,996

(22) Filed: Jun. 5, 2024

(30) Foreign Application Priority Data
Jun. 5, 2023 (CN) 202321408558.4

(51) Int. Cl. B25B 21/00; B25B 13/46

(52) U.S. Cl. CPC B25B 21/004; B25B 13/463

(57) ABSTRACT

A ratchet assembly is configured to rotate a fastener in both a clockwise and counter-clockwise direction. The ratchet assembly includes a yoke, a drive, a left pawl, a right pawl, and a shuttle assembly. The yoke defines a fastening hole. The drive is rotatably coupled to the yoke and is supported in the fastening hole. The left pawl is supported in the yoke and is biased toward the drive by a first biasing member. The right pawl is supported in the yoke and is biased toward the drive by a second biasing member. The shuttle assembly is rotatably supported in the yoke between the left and right pawls and selectively engages the left and right pawl. The directional knob is coupled to the shuttle assembly.

### CROSS-REFERENCE TO RELATED APPLICATIONS

This application claims priority to Chinese Utility Model application No. 202321408558.4, filed Jun. 5, 2023, the entire content of which is incorporated herein by reference.

### FIELD

The present disclosure relates to ratchet tools, and more particularly, to a ratchet assembly and drive assembly of a box ratchet.

### BACKGROUND

Box ratchets may facilitate tightening or loosening a fastener in a confined space where rotation of a tool about a 360 degree axis cannot be undertaken. To that end, a ratchet assembly of a box ratchet provides for tightening of a fastener in one rotational direction while allowing free rotation of the box ratchet in the opposite direction, thereby providing uni-directional tightening of the fastener without subsequently loosening the fastener as the box ratchet is rotated in the opposite direction, without having to disengage the box ratchet from the fastener to continue the fastening operation.

### SUMMARY

In some aspects, the techniques described herein relate to a ratchet assembly configured to rotate a fastener in both a clockwise and a counterclockwise direction, the ratchet assembly including: a yoke defining a fastening hole; a drive rotatably coupled to the yoke and supported in the fastening hole; a first pawl supported in the yoke and biased toward the drive by a first biasing member; a second pawl supported in the yoke and biased toward the drive by a second biasing member; a shuttle assembly rotatably supported in the yoke between the first pawl and the second pawl; and a directional knob coupled to the shuttle assembly.

In some aspects, the techniques described herein relate to a ratchet tool including: a housing including a drive housing in which a motor is supported and a yoke housing extending from the drive housing; a crankshaft coupled to the motor and rotatable therewith about a crankshaft axis, the crankshaft at least partially supported in the yoke housing and including a coupling portion having a coupling axis radially offset from the crankshaft axis; a ratchet assembly pivotally coupled to the yoke housing and operably engaged to the coupling portion, the ratchet assembly including a yoke, a first pawl and a second pawl pivotably coupled to the yoke, a drive rotatably supported in the yoke between the first pawl and the second pawl, and a first biasing member biasing the first pawl into engagement with the drive, and a second biasing member biasing the second pawl into engagement with the drive.

In some aspects, the techniques described herein relate to a ratchet tool including: a housing including a drive housing in which a motor is supported and a yoke housing extending from the drive housing; a crankshaft coupled to the motor and rotatable therewith about a crankshaft axis, the crankshaft at least partially supported in the yoke housing and including a coupling portion having a coupling axis radially offset from the crankshaft axis; a ratchet assembly pivotally coupled to the yoke housing and operably engaged to the coupling portion, the ratchet assembly including a yoke, a pawl pivotably coupled to the yoke such that the pawl is pivotable about a pawl axis, and a drive rotatably supported in the yoke such that the drive is rotatable about a drive axis, the drive including a fastening hole defining a circumscribed circle having a diameter of less than 16.5 millimeters, wherein a distance between the pawl axis and the fastening axis is as least 25 millimeters.

Other features and aspects of the disclosure will become apparent by consideration of the following detailed description and accompanying drawings.

### BRIEF DESCRIPTION OF THE DRAWINGS

FIG. 1 is a perspective view of a box ratchet according to an embodiment of the present disclosure.

FIG. 2 is a partial section view of the box ratchet of FIG. 1, illustrating a motor and gear assembly.

FIG. 3 is an exploded view of the box ratchet of FIG. 1, illustrating the motor and gear assembly.

FIG. 4 is a partial section view of the box ratchet of FIG. 1.

FIG. 5 is a section view of the ratchet assembly of the box ratchet of FIG. 1.

FIG. 6 is a section view of the ratchet assembly of box ratchet of FIG. 1.

FIG. 7 is a perspective view of the yoke of the ratchet assembly of FIG. 1.

FIG. 8 is an exploded view of the ratchet assembly of FIG. 1, illustrating an embodiment of a forward-reverse mechanism.

FIG. 9 is a top partial view of the ratchet assembly of FIG. 1.

FIG. 10 is a section view of the ratchet assembly of FIG. 1, illustrating the forward-reverse mechanism position.

FIG. 11 is a top partial view of the box ratchet of FIG. 1.

FIG. 12 is a section view illustrating the ratchet assembly of FIG. 8, including a forward-reverse shuttle.

FIG. 13 is a section view illustrating the ratchet assembly of FIG. 8, including the forward-reverse shuttle.

FIG. 14 is a section view illustrating the ratchet assembly of FIG. 8, including the forward-reverse shuttle.

FIG. 15 is an exploded view of another embodiment of a ratchet assembly, illustrating the forward-reverse assembly.

FIG. 16 is a section view of the ratchet assembly of FIG. 15, illustrating the forward-reverse shuttle.

FIG. 17 is a section view of the ratchet assembly of FIG. 15, illustrating the forward-reverse shuttle.

FIG. 18 is a graph illustrating the torque-rotation angle curve of the forward-reverse knob of the ratchet assembly of FIG. 1.

FIG. 19 is a top view of another embodiment of a forward-reverse assembly of a box ratchet.

FIG. 20 is a top view of another embodiment of a forward-reverse assembly of a box ratchet.

FIG. 21 is a top view of another embodiment of a forward-reverse assembly of a box ratchet.

FIG. 22 is a top view of another embodiment of a forward-reverse assembly of a box ratchet.

FIG. 23 is a section view of another embodiment of a ratchet assembly, illustrating an idler pawl.

FIG. 24A is a perspective view of an accessory that is couplable to the box ratchet.

FIG. 24B is a perspective view of an accessory that is couplable to the box ratchet.

FIG. 24C is a perspective view of an accessory that is couplable to the box ratchet.

FIG. 24D is a perspective view of an accessory that is couplable to the box ratchet.

FIG. 24E is a side section view of an accessory that is coupled to the box ratchet.

FIG. 24F is a section view of an accessory that is couplable to the box ratchet.

FIG. 25A is a side view of a box ratchet, including an accessory coupled to the box ratchet.

FIG. 25B is a side view of a box ratchet, including an accessory coupled to the box ratchet.

FIG. 25C is a side view of a box ratchet, including an accessory coupled to the box ratchet.

FIG. 26 is a side view of a box ratchet, including an accessory coupled to the box ratchet.

FIG. 27 is a section view of a box ratchet, including an accessory coupled to the box ratchet.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Terms of degree, including “about,” “substantially,” “approximately,” etc., as used herein, are understood by those of ordinary skill to refer to reasonable ranges outside of the given value, for example, general tolerances associated with manufacturing, assembly, and use of the described embodiments.

### DETAILED DESCRIPTION

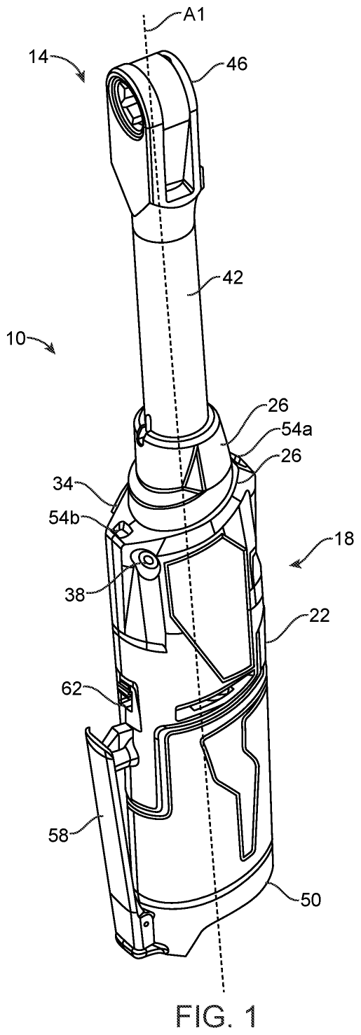

FIG. 1 illustrates a ratchet tool 10 in the form of a box ratchet configured to rotate a fastener in clockwise and counterclockwise directions via a ratchet assembly 14. The ratchet tool (also referred to herein simply as “tool”) 10 includes a housing 18 that has a shell 22 and a drive housing 26 that at least partially extends from and is supported in the shell 22. In the present embodiment, a pair of clamshell halves 30, 34 form the shell 22, although the shell 22 may be formed in another manner. As illustrated, the drive housing 26 is coupled to the shell 22 via fasteners 38 spaced circumferentially about the shell 22. In other embodiments, the drive housing 26 may be coupled to the shell 22 via a tongue-in-groove joint or other manner of coupling the drive housing 26 at least partially within the shell 22. A yoke housing 42 is coupled to and extends from the drive housing 26. A tool axis A1 is defined along the length of the housing 18. The ratchet assembly 14 is positioned at a distal end 46 of the yoke housing 42. As illustrated, the drive housing 26 and yoke housing 42 are formed separately and coupled together. In some embodiments, the drive housing 26 and yoke housing 42 may instead be integrally formed. A battery pack (not shown, but which may be, for instance, a 12 volt battery pack, or a battery pack with another voltage capacity) may be removably coupled to the tool 10 at a first end 50 of the housing 18, for instance, by sliding the battery pack into the housing 18.

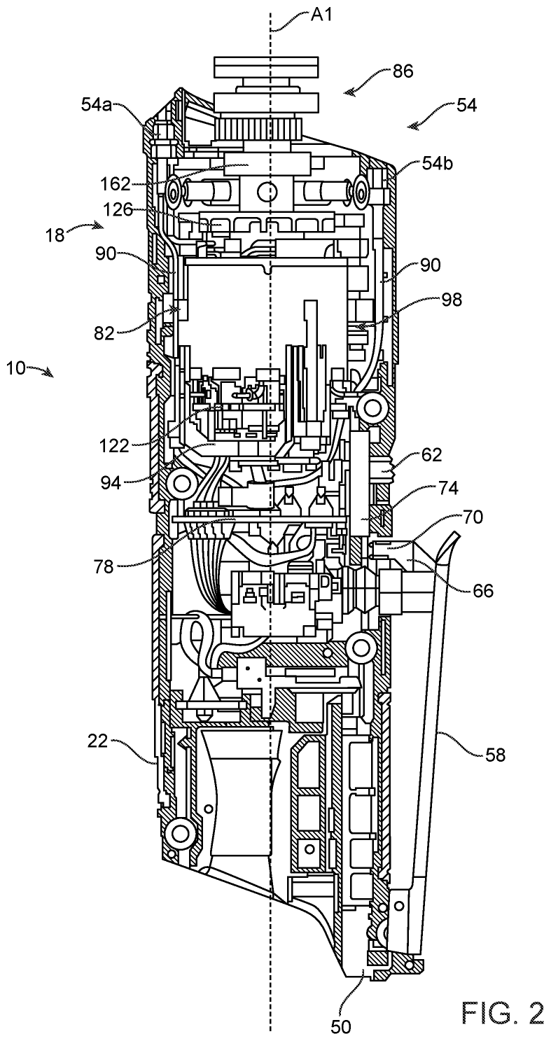

The tool 10 includes one or more LEDs 54 disposed in the housing 18 (e.g., in the shell 22) to direct light along the yoke housing 42 toward the ratchet assembly 14 to illuminate a fastener on which the tool 10 is operating. As illustrated, the tool 10 includes two LEDs 54a, 54b spaced about 180 degrees apart. With reference to FIG. 2, the first LED 54a is spaced approximately 23.7 mm above (illustrated as being in a direction toward the left side of the page) the tool axis A1 and the second LED 54b is spaced approximate 25 millimeters below (illustrated as being in a direction toward the right side of the page) the tool axis A1. In other embodiments, the tool 10 may include fewer or more LEDs arranged in another manner. For instance, the LEDs may include three LEDs arranged in an annular pattern about the tool axis A1. In some embodiments, a lens (not shown) may be disposed over each LED 54 and may include a patterned surface to diffuse the light emitted by the LEDs. A reflective surface (not shown) may be positioned opposite (i.e., behind) each LED to direct light toward the ratchet assembly 14.

With reference to FIGS. 1 and 2, a switch 58 (e.g., trigger) is pivotably coupled to the housing 18 at the first end 50 of the housing 18 and is electrically coupled to the tool 10 such that engagement of the switch 58 activates the tool 10. A trigger lock 62 is also supported in the housing 18. The trigger lock 62 is movable, for instance, by sliding, between an unlocked position (shown in FIG. 2) and a locked position. In the unlocked position, the trigger lock 62 allows pivoting of the switch 58 to permit activation of the tool 10. In the locked position, the trigger lock 62 prevents pivoting of the switch 58, thereby preventing activation of the tool 10.

With continued reference to FIG. 2, the switch 58 and trigger lock 62 are shown in more details. The switch 58 includes a stop 66 that has an engagement portion 70 that extends from the switch 58 toward and into the shell 22. The trigger lock 62 is supported in the shell 22 adjacent the stop 66. By sliding the trigger lock 62 from the unlocked position to the locked position (illustrated as in a direction toward the bottom of the page), a plate portion 74 of the trigger lock 62 is positioned such that the engagement portion 70 contacts the plate portion 74 when the switch 58 is depressed, preventing further depression of the switch 58, and thereby, activation of the tool 10.

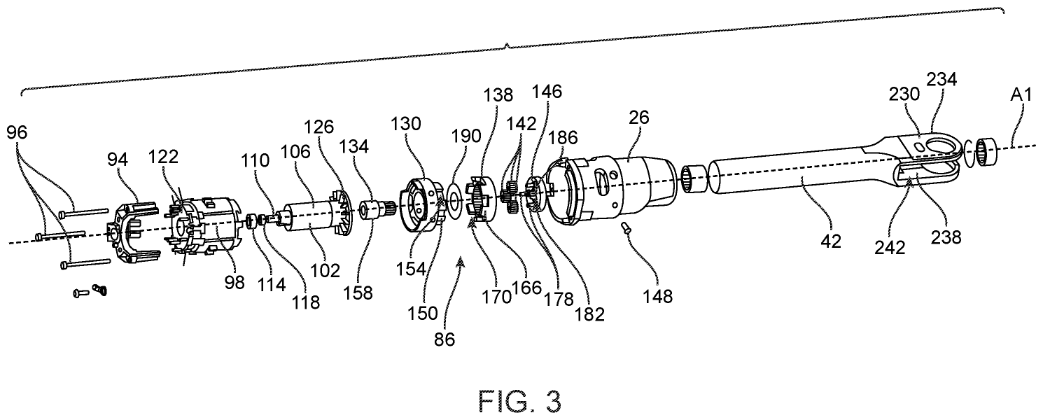

With reference to FIGS. 2 and 3, a printed circuit board assembly (“PCBA”) 78, motor 82, and gear assembly 86 are supported in the housing 18. The PCBA 78 includes a controller that controls operation of the tool 10. The LEDs 54 are electrically coupled to the PCBA 78 via wiring 90 that extends along the drive housing 26 to the PCBA 78. In other embodiments, the tool 10 may include a separate PCBA to which the LEDs 54 are electrically coupled and which controls operation of the LEDs 54.

The motor 82 is supported in the housing 18 by the drive housing 26 and an end cap 94 coupled to the drive housing 26 (e.g., by fasteners 96). The motor 82 includes a stator 98 and rotor 102. The stator 98 is fixed in the drive housing 26 against rotation and the rotor 102, which includes a rotor body 106, is rotationally supported within the stator 98 such that the rotor 102 is rotatable relative to the stator 98. A rotor shaft 110 is fixed to the rotor body 106 and is rotatable therewith. A first bearing 114 is coupled to a first end 118 of the rotor shaft 110 and the end cap 94 to support the rotor 102 within the stator 98 and allow rotation of the rotor 102 relative to the stator 98.

A second PCBA 122 is supported within the end cap 94 between the stator 98 and the first end 118 of the rotor shaft 110. The second PCBA 122 includes a sensor (e.g., a position sensor such as a Hall effect sensor) to ascertain information about the motor 82 which is provided to the controller.

A fan 126 is coupled to the rotor shaft 110 for rotation with the rotor 102, and may be positioned for instance, between the stator 98 and the gear assembly 86 to direct an airflow around the motor 82 to cool the motor 82. In other embodiments, the fan 126 may be coupled adjacent the first end 118 of the rotor shaft 110 such that the stator 98 is positioned between the fan 126 and the gear assembly 86.

The gear assembly 86 is supported in the drive housing 26 and is operationally coupled to the rotor shaft 110 to receive a rotational input. As illustrated, the gear assembly 86 is a planetary gear assembly. The gear assembly 86 includes an anti-rotation collar 130, a pinion 134, a ring gear 138, and a plurality of planetary gears 142 coupled to a carrier 146. In other embodiments, other types of gear assemblies may be used, or the gear assembly 86 may be omitted altogether.

The anti-rotation collar 130 is coupled to the drive housing 26 and is engaged by the anti-rotation pin 148 which is at least partially disposed in the drive housing 26 and the anti-rotation collar 130, thereby preventing rotation of the anti-rotation collar 130 relative to the drive housing 26. In other embodiments, the anti-rotation collar 130 may be press-fit in the drive housing 26 and/or contain a keyway in which a key is disposed that engages the drive housing 26 to prevent rotation of the anti-rotation collar 130. In still other embodiments, the anti-rotation collar 130 may be coupled to the drive housing 26 by fasteners. In yet other embodiments, projections and recesses from the ring gear 138 may engage the drive housing 26. The anti-rotation collar 130 includes a plurality of projections 150 that extend along the tool axis A1 away from the rotor 102 and are spaced evenly about the circumference of the anti-rotation collar 130. The projections 150 define recesses 154 therebetween.

The pinion 134 is coupled to the rotor shaft 110 for rotation with the rotor shaft 110. The pinion 134 defines teeth 158 that engage the planetary gears 142 to transmit the rotational motion of the rotor shaft 110 to the gear assembly 86, and thereby, the ratchet assembly 14.

A second bearing 162 is coupled to the pinion 134 and the anti-rotation collar 130 to support the rotor shaft 110 and the pinion 134 and allow rotation of the rotor shaft 110 and the pinion 134 relative to the drive housing 26.

The ring gear 138 is disposed in the drive housing 26 adjacent to and engaging the anti-rotation collar 130. In that regard, the ring gear 138 defines a plurality of projections 166 and recesses 170 therebetween spaced equidistantly about the circumference of the ring gear 138 that extend along the tool axis A1 toward the motor 82. The projections 166 and recesses 170 of the ring gear 138 align with and engage the recesses 154 and projections 150 of the anti-rotation collar 130 thereby preventing rotation of the ring gear 138 relative to the anti-rotation collar 130 and the drive housing 26. In other embodiments, the ring gear 138 is press-fit within the drive housing 26 thereby preventing rotation of the ring gear 138 relative to the drive housing 26. The ring gear 138 defines a gear portion 174 on an interior diameter of the ring gear 138.

The planetary gears 142 and carrier 146 are disposed in the drive housing 26 radially within the ring gear 138. The planetary gears 142 are disposed around and engage the teeth 158 of the pinion 134, and are rotationally supported on the carrier 146 by shafts 178 extending from the carrier 146 along the tool axis A1 toward the motor 82. In the illustrated embodiment, the tool 10 includes three planetary gears 142, although other quantities may be used instead. The carrier 146 is rotatable relative to the drive housing 26 and defines a cutout 182 having gear teeth 186.

The planetary gears 142 engage the pinion 134 and the ring gear 138 and rotation of the pinion 134 results in rotation of the planetary gears 142 relative to the carrier 146. Engagement of the planetary gears 142 with the ring gear 138 results in circular translation of the planetary gears 142 about the tool axis A1 and rotation of the carrier 146, thus transferring a rotational motion of the rotor shaft 110 to the carrier 146. In the present embodiment, a shim 190 having an annular profile is disposed between the anti-rotation collar 130 and the planetary gears 142.

In some embodiments, the gear assembly 86 is a first gear stage and the tool 10 may include additional gear stages that engage the carrier 146 to further reduce the rotational speed of the tool 10.

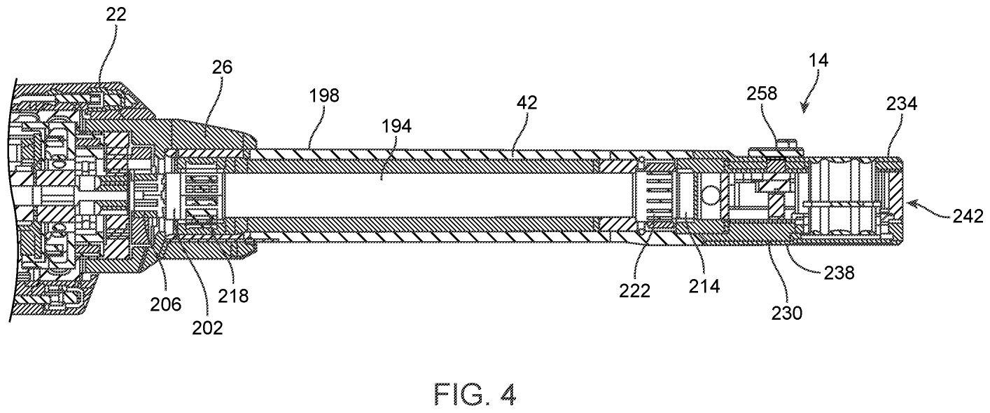

With reference to FIGS. 4-6, a crankshaft 194 is at least partially disposed in an elongated extension portion 198 of the yoke housing 42. A first end 202 of the crankshaft 194 engages the carrier 146 of the gear assembly 86 and is rotatable about the tool axis A1 with the carrier 146. As illustrated, the first end 202 of the crankshaft 194 includes a gear portion 206 that engages and meshes with the gear teeth 186 of the cutout 182 of the carrier 146. In other embodiments, the crankshaft 194 may be coupled to the carrier 146 in another manner. The crankshaft 194 further defines a coupling portion 210 that extends from the second end 214 of the crankshaft 194. The coupling portion 210 defines a coupling axis A2 that is radially offset from the tool axis A1 such that the coupling portion 210 is eccentrically oriented relative to the crankshaft 194. The crankshaft 194 is rotationally supported in the yoke housing 42 by first and second bearings 218, 222 (e.g., roller bearings) disposed at the first and second ends 202, 214 of the crankshaft 194. Another bearing 226 (e.g., a spherical bearing) is coupled to the coupling portion 210 of the crankshaft 194. The bearing 226 engages the ratchet assembly 14 and transmits rotation of the coupling portion 210 of the crankshaft 194 to the ratchet assembly 14.

With continued reference to FIGS. 4-6, the ratchet assembly 14 is shown in greater detail. The ratchet assembly 14 is pivotally coupled to a ratchet portion 230 of the yoke housing 42 at the distal end 46 of the yoke housing 42. The ratchet assembly 14 is pivotable relative to the yoke housing 42 about a fastening axis A3 which is substantially perpendicular to the tool axis A1, although other angular relationships between the tool axis A1 and the fastening axis A3 may be present in other embodiments. As shown in FIG. 3, the ratchet portion 230 includes upper and lower flanges 234, 238 that define a cavity 242 therebetween. Returning to FIGS. 4-6, the upper and lower flanges 234, 238 define a width W and ratchet height H1 of the ratchet portion 230. In the present embodiment, the upper and lower flanges 234, 238 have a width W of 30 millimeters and a ratchet height H1 of 21.5 millimeters, although other widths and heights which facilitate operation of the tool 10 in enclosed spaces with limited space for rotation of the tool 10 may be used. For instance, the tool 10 may have a ratchet height H1 that is less than 21.8 millimeters. Each of the upper and lower flanges 234, 238 includes a fastening hole 246, 250 through which a fastener or an accessory can be inserted to engage the ratchet assembly 14. The upper flange 234 also includes a hole 254 through which a directional knob 258 of the ratchet assembly 14 is inserted.

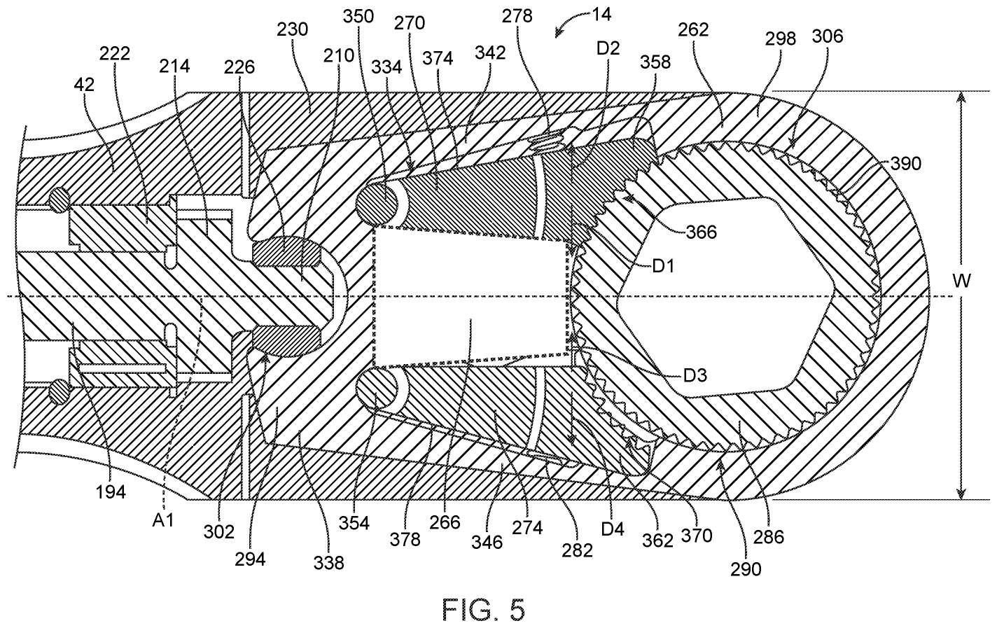

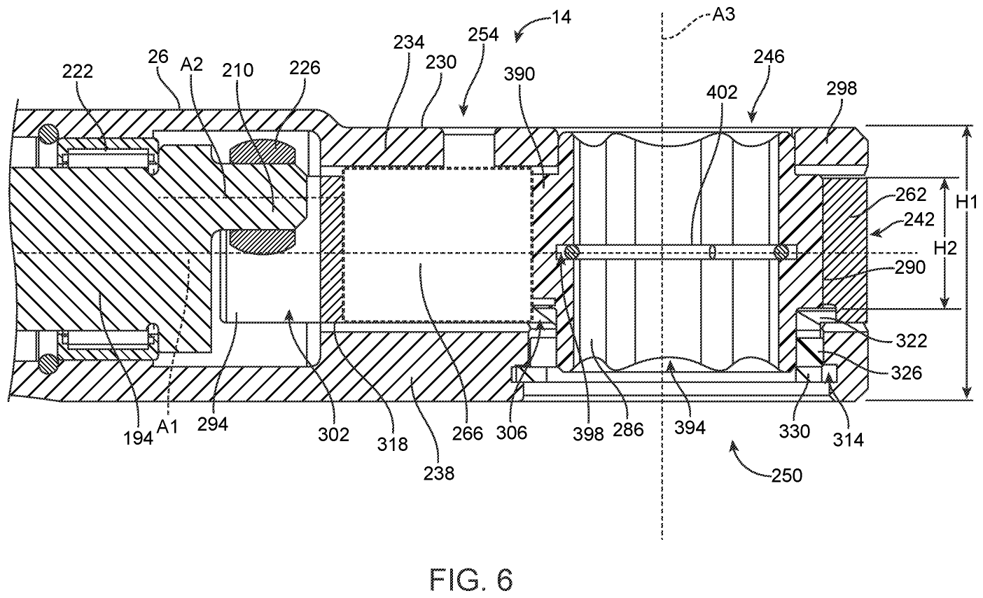

The ratchet assembly 14 includes a yoke 262, a forward-reverse assembly 266 (illustrated schematically in FIGS. 5 and 6), a left pawl 270 and a right pawl 274, biasing members (e.g., a first biasing member 278 and a second biasing member 282), and a drive 286, which, in the illustrated embodiment, includes a splined outer periphery 290 configured to interface with the pawls 270, 274, as described in greater detail below.

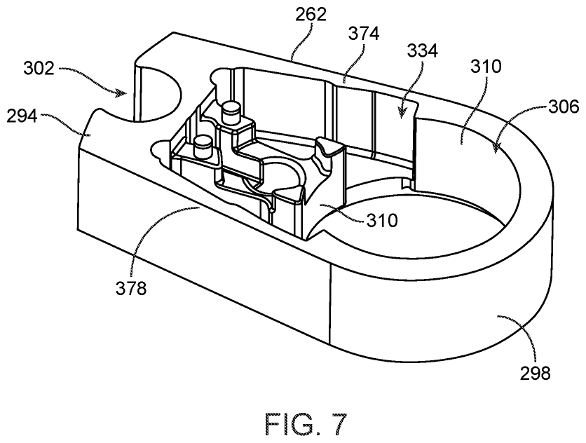

Referring to FIG. 7, the yoke 262 defines an engagement portion 294 and an opposite, rounded end portion 298. The engagement portion 294 includes a recess 302 having a semi-circular cross-section that receives the coupling portion 210 of the crankshaft 194 and the bearing 226. The yoke 262 further defines a fastening hole 306 having a plurality of surfaces 310 that are substantially concentric with the rounded end portion 298. Returning to FIGS. 5 and 6, the drive 286 is received in the fastening hole 306. A spline-yoke engagement distance H2 (hereinafter “engagement distance”) is defined by the length of engagement between the drive 286 and the surfaces 310 of the drive 286. In the present embodiment, the engagement distance H2 is greater than 4 mm, for instance, 10 mm. It will be appreciated by those skilled in the art that as the engagement distance H2 increases, the allowable tilt angle of the drive 286 in the fastening hole 306 is reduced. At least one groove 314 concentric with the fastening hole 306 is positioned in the ratchet portion 230 of the yoke housing 42 adjacent a bottom face 318 of the yoke 262 and is configured to receive and retain retention structures (e.g., a two-turn wave spring 322, a friction plate 326, and a retaining ring 330). The retention structures may instead include a wave washer or other structures to retain the drive and maintain rotational position of the drive. A cavity 334 extends from a top face 338 of the yoke 262 and is configured to receive the left and right pawls 270, 274, the forward-reverse assembly 266, and the first and second biasing members 278, 282. The cavity 334 defines outer walls 342, 346 extending between the engagement portion 294 and the rounded end portion 298.

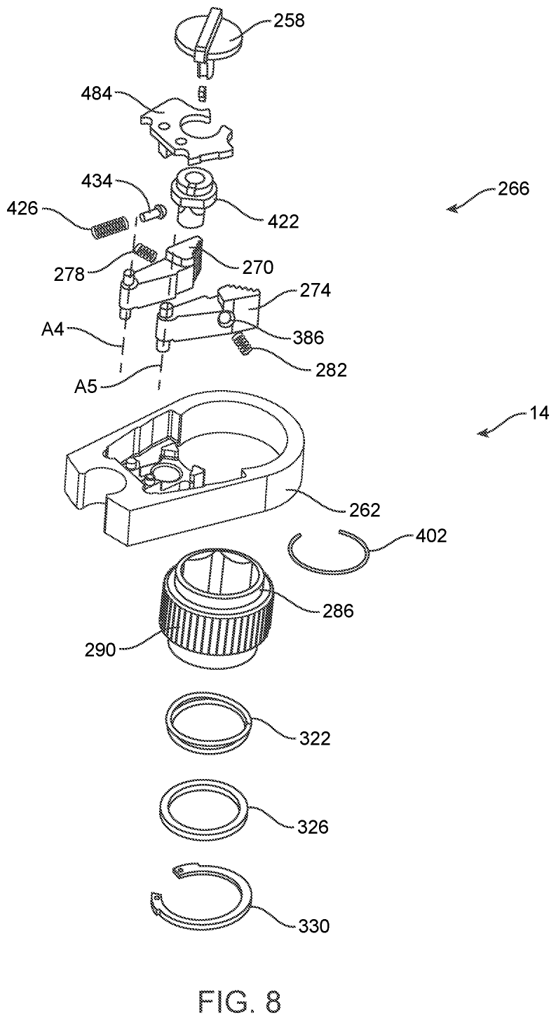

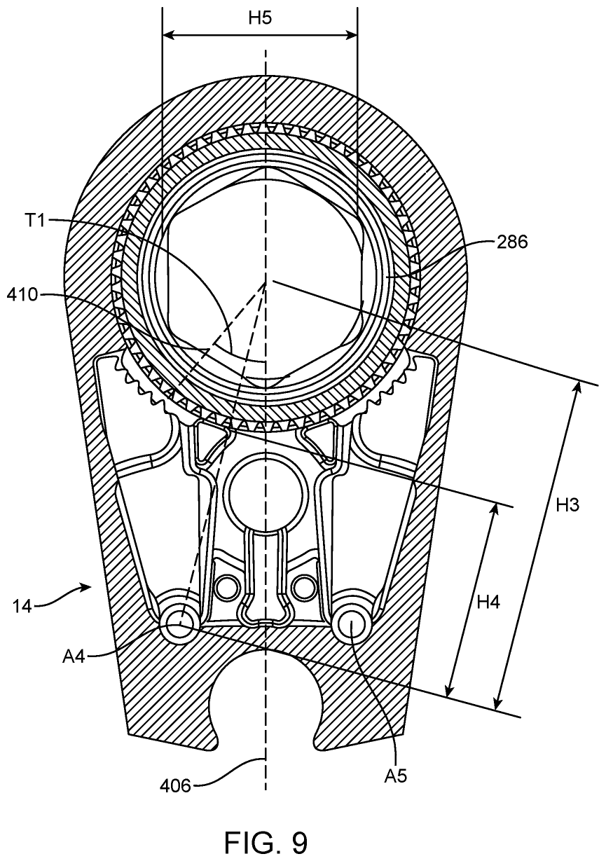

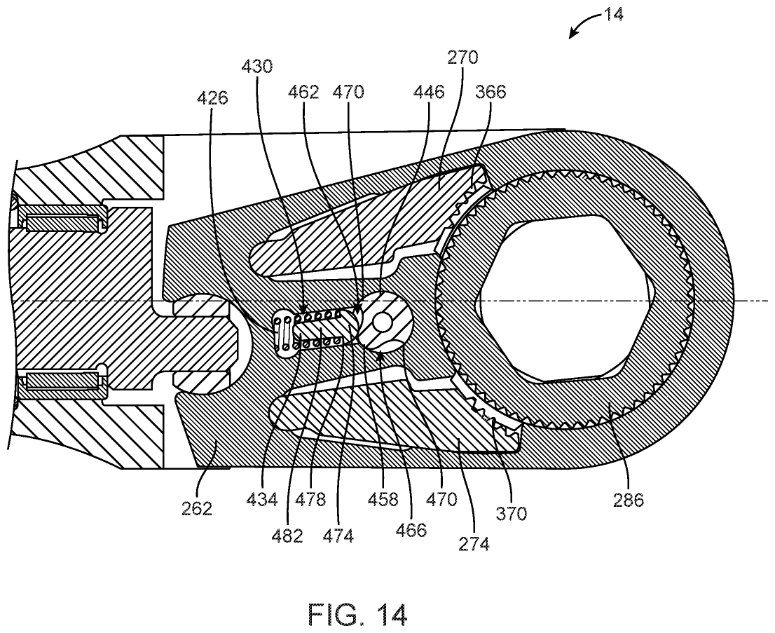

The left pawl 270 and the right pawl 274 are pivotally coupled to the yoke 262, with each pawl 270, 274 rotatable about a pawl rotational axis (e.g., a first pawl rotational axis A4, a second pawl rotational axis A5, shown in FIG. 8) relative to the yoke 262. In that regard, the left pawl 270 is rotatable about the first pawl rotational axis A4 in a first direction D1 toward the drive 286 and a second direction D2 away from the drive 286, and the right pawl 274 is rotatable about the second pawl rotational axis A5 in a first direction D3 toward the drive 286 and a second direction D4 away from the drive 286. Each of the left pawl 270 and the right pawl 274 define a coupling portion 350, 354 pivotally coupled to the yoke 262 and an opposite engagement portion 358, 362 that defines pawl teeth 366, 370. In some embodiments, the left and right pawls 270, 274 include five teeth (FIGS. 9, 14), however, another quantity of pawl teeth 366, 370 may be used instead. It will be appreciated by those skilled in the art that the size of the teeth of a pawl having more than one tooth (e.g., five teeth) may be decreased in comparison to the size of the tooth of a pawl having only one tooth while still maintaining substantially equivalent durability. It will also be appreciated that a smaller tooth size allows the size of the tool 10 to be decreased while maintaining functionality of the tool. Outer walls 374, 378 extend between the coupling portion 350, 354 and the engagement portion 358, 362 of each of the left pawl 270 and the right pawl 274. In some embodiments, a bore 382, 386 (FIG. 8) extends into the outer walls 374, 378 of the left and right pawls 270, 274.

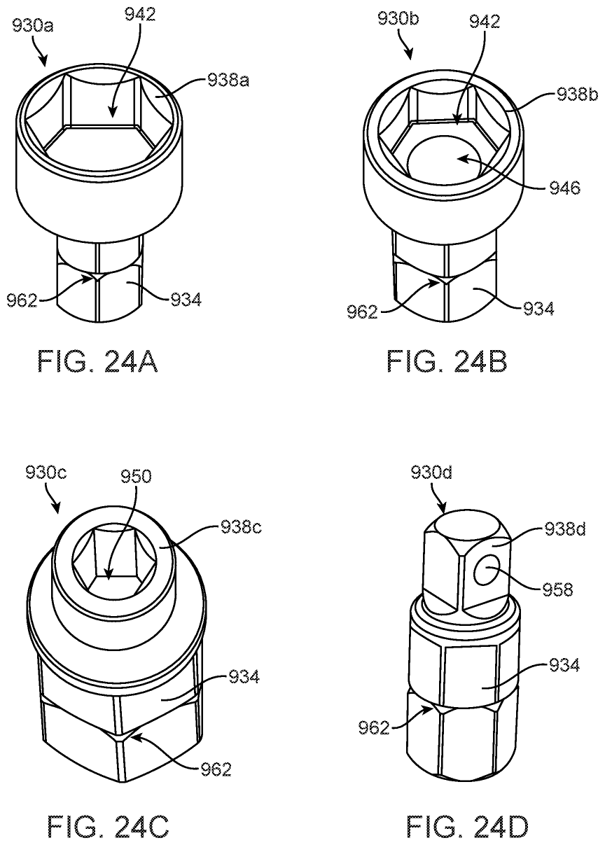

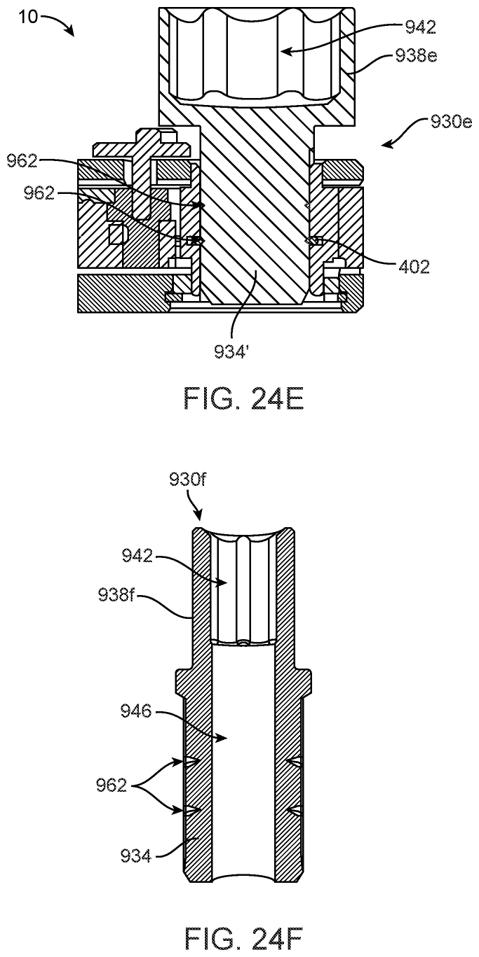

The drive 286 is rotatably supported in the fastening hole 306 of the yoke 262, at least partially between the left and right pawls 270, 274, and rotates about the fastening axis A3. The splined outer periphery 290 of the drive 286 defines a plurality of teeth 390 positioned circumferentially about the outer periphery 290. The drive 286 further defines an insertion hole 394. As illustrated, the insertion hole 394 has a hexagonal cross-section. In other embodiments, the insertion hole 394 may have a different cross section (e.g., square, Torx, etc.). A groove 398 extends about the circumference of the insertion hole 394 and receives an accessory retention spring 402 therein. The accessory retention spring 402 may be an O-ring made of a resilient material. The accessory retention spring 402 extends at least partially into the insertion hole 394 (in a radially inward direction) and may engage an accessory (e.g., a socket 930a-c, e, f, the adapter 930d illustrated in FIGS. 24A-F and described in greater detail below, etc.) to frictionally retain the accessory within the insertion hole 394. In other embodiments, the drive 286 may include detent balls or other retention structures configured to maintain the coupled relationship of an accessory and the drive 286.

As illustrated in FIG. 9, the ratchet assembly 14 defines a line between the fastening axis A3 and the pawl rotational axes A4, A5. A center-to-center distance H3 is defined between the fastening axis A3 and each pawl rotational axis A4, A5. A pawl distance H4 is defined between the pawl rotational axes A4, A5 and the outer periphery 290 of the drive 286 along the line. In the illustrated embodiment, the ratchet assembly 14 has a center-to-center distance H3 of approximately 26.7 millimeters, a pawl distance H4 of approximately 15.2 millimeters, and a ratio of the pawl distance H4 to the center-to-center distance H3 is approximately 0.56. In other embodiments, the ratio of the pawl distance H4 to the center-to-center distance H3 may be greater than 0.25, for instance, within a range of 0.25 to 0.75. The ratchet assembly 14 further defines an engagement angle Tl (e.g., approximately 35 degrees in the illustrated embodiment or greater than or equal to approximately 25 degrees in some embodiments) between the centerline 406 of the yoke 262 and a line 410 defined between the fastening axis A3 and the first tooth of each of the left and right pawls 270, 274 when the pawls 270, 274 are engaged with the drive 286. A ratio of the center-to-center distance H3 to the width W of the yoke 262 is between 0.7 and 0.9 (e.g., approximately 0.89 in the illustrated embodiment) and a ratio of the pawl distance H4 to the width W of the yoke 262 is between 0.1 and 0.2 (e.g., approximately 0.13 in the illustrated embodiment). In other embodiments, the ratchet assembly 14 may have a center-to-center distance H3 and a pawl distance H4 with other values.

Returning to FIGS. 5 and 8, the first and second biasing members 278, 282 engage the left and right pawls 270, 274 and bias the left and right pawls 270, 274 toward the drive 286. In the illustrated embodiment, the left and right pawls 270, 274 are compression springs that are supported in the bores 382, 386 (the bore 382 in the left pawl 270 is substantially identical to the bore 386 of the right pawl 274, shown in FIG. 8) of the left and right pawls 270, 274 and engage the outer walls 342, 346 of the yoke 262 to bias the left and right pawls 270, 274 toward the drive 286. Specifically, the first biasing member 278 supported in the bore 382 of the left pawl 270 imparts a biasing force on the left pawl 270 in the first direction D1, resulting in a moment about the first pawl rotational axis A4 in the first direction D1. The second biasing member 282 is supported in the bore 386 of the right pawl 274 and imparts a biasing force on the right pawl 274 in the first direction D3, toward the drive 286, resulting in a moment (i.e., a third moment) about the second pawl rotational axis A5. In another embodiment, the first and second biasing members 278, 282 may be torsion springs that engage the left and right pawls 270, 274 and the yoke 262 to bias the pawls 270, 274 toward the drive 286. In yet another embodiment, the first and second biasing members 278, 282 may be tension springs coupled to the left and right pawls 270, 274 that bias the left and right pawls 270, 274 toward the drive 286. In still other embodiments, other types of springs, or another structure that can impart a moment on the left and right pawls 270, 274 may instead be used.

The forward-reverse assembly 266 is supported in the cavity 334 of the yoke 262 between the left and right pawls 270, 274. The forward-reverse assembly 266 is configured to selectively disengage the left and right pawls 270, 274 with the drive 286 for user selection of the operational direction (i.e., the rotational direction in which tightening or loosening of a fastener is accomplished) of the ratchet assembly 14.

With reference to FIGS. 5, 6, and 10, engagement of the right pawl 274 with the drive 286 and positioning of the ratchet assembly 14 and the coupling portion 210 of the crankshaft 194 are illustrated in more detail. In response to actuation of the switch 58 and the motor 82, the crankshaft 194, and the coupling portion 210 with it, are rotated about the tool axis A1. Upon rotation of the coupling portion 210 about the tool axis A1, engagement of the bearing 226 with the yoke 262 rotates the ratchet assembly 14 in a periodic, or alternating, clockwise-and-counterclockwise about the fastening axis A3.

As the ratchet assembly 14, and the left and right pawls 270, 274 with it, are rotated in a periodic pattern, one of the left or right pawl 270, 274, the driving pawl, depending on the position of the forward-reverse assembly 266, will be engaged with the drive 286 as a result of the moment applied by the first or second biasing member 278, 282, while the other of the left and right pawls 270, 274, the disengaged pawl, will be biased away from and out of engagement with the drive 286 by the forward-reverse assembly 266.

In an exemplary operation of the tool 10, rotation of the ratchet assembly 14 in a first direction (e.g., counter-clockwise) about the fastening axis A3 results in driving engagement of the driving pawl (e.g., the right pawl 274) with the drive 286 (i.e., the pawl teeth 370 engage and push the teeth 390 of the drive 286) that rotates and advances the drive 286 about the fastening axis A3 and rotation of the ratchet assembly 14 in the opposite, second direction (e.g., clockwise) about the fastening axis A3 results in sliding engagement of the driving pawl (e.g., the right pawl 274), whereby the pawl teeth 370 of the driving pawl 274 slide over the teeth 390 of the drive 286 and the drive 286 remains stationary. It will be appreciated by those skilled in the art that the engagement distance H2 and resulting tilt angle of the drive 286 improves meshing of the pawls 270, 274 with the drive 286 thereby increasing durability in comparison to a drive with a greater tilt angle, without requiring employment of tighter tolerancing of the yoke and drive to maintain the same tilt angle.

In response to rotation of the ratchet assembly 14 and engagement of the left or right pawl 270, 274 with the drive 286, a frictional force between the drive 286 and the left or right pawl 270, 274 is induced, which imparts a frictional moment on the left or right pawl 270, 274 in the first direction D1, D3 toward the drive 286 about the left or right pawl rotational axis A4, A5. That is, when the left pawl 270 is engaged with the drive 286, the frictional force imparted by the spline teeth 390 on the left pawl 270 results in a frictional moment about the left pawl rotational axis A4 in the first direction D1 toward the drive 286. When the right pawl 274 is engaged with the drive 286, the frictional force imparted by the spline teeth 390 on the right pawl 274 results in a frictional moment about the right pawl rotational axis A5 in the first direction D3 toward the drive 286. Rotation of the drive 286 or the ratchet assembly 14 will relieve the frictional force of the drive 286 on the pawls 270, 274.

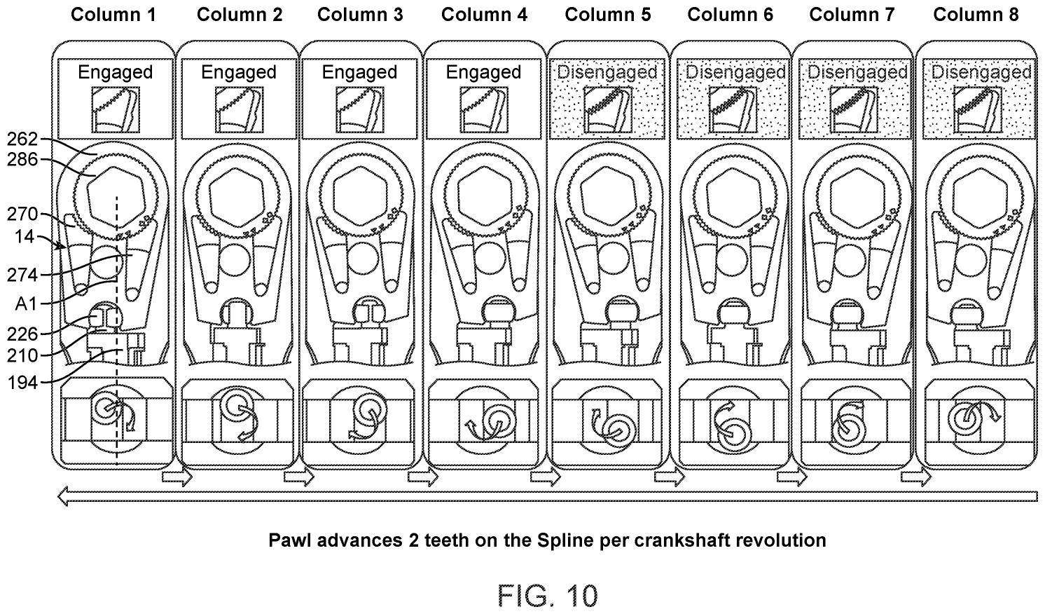

With continued reference to FIG. 10, an exemplary rotational operation sequence of the tool 10 is illustrated in further detail. The first column illustrates an exemplary starting rotational position of the crankshaft 194 and ratchet assembly 14. As the crankshaft 194 and coupling portion 210 begin rotation about the tool axis A1 from the initial rotational position, the ratchet assembly 14 is pivoted in a first direction (e.g., counterclockwise) about the fastening axis A3. As the coupling portion 210 rotates through 180 degrees (columns 2, 3, and 4), the bearing 226 engages the yoke 262 and continues to rotates the ratchet assembly 14 in the first direction. The pawl teeth 370 of the right pawl 274 are engaged with the teeth 390 of the drive 286 while the left pawl 270 is biased out of engagement with the drive 286 by the forward-reverse assembly 266. Engagement of the pawl teeth 370 with the teeth 390 of the drive 286 rotationally advances the drive 286 relative to the yoke housing 42. As the crankshaft 194 and coupling portion 210 pass through 180 degrees of rotation (columns 4 to 5), the ratchet assembly 14 reaches the end of the rotational stroke as a result of the position of the coupling portion 210, and the ratchet assembly 14 begins rotation in the opposite, second direction (e.g., clockwise). As the ratchet assembly 14 proceeds in the second direction (columns 5-8), the pawl teeth 370 of the right pawl 274 slide along the teeth 390 of the drive 286 without engaging and advancing the drive 286 in the second direction (e.g., counterclockwise). As the crankshaft 194 completes its 360-degree rotation, the ratchet assembly 14 completes a stroke in the second direction (clockwise). At the completion of rotation of the crankshaft 194 and resulting completion of the ratchet assembly stroke, the right pawl 274 has advanced to a position (left triangular and left square indicators in column 8 of FIG. 10) that is at least one spline tooth (e.g., two spline teeth, four spline teeth, or another number of spline teeth) from the initial starting position (right triangular and square indicators in column 8 of FIG. 10) of the right pawl 274 relative to the drive 286. In other embodiments, the ratchet assembly 14 may be configured such that a greater or smaller advancement of the right pawl 274 relative to the drive 286 may occur.

As illustrated, the right pawl 274 is biased into engagement with the drive 286 via the second biasing member 282. The left pawl 270 may instead be biased into engagement with the drive 286, in which embodiment, the engagement and disengagement of the left pawl 270 with the drive 286 would be reversed for the rotational positions of the crankshaft 194 illustrated in FIG. 10. That is, the left pawl 270 would be disengaged at the rotational position of the crankshaft 194 shown in columns 1-4 of FIG. 10 and would be engaged for rotational positions of the crankshaft 194 shown in columns 5-8 of FIG. 10.

FIGS. 8 and 11-14 illustrate a ratchet assembly 14 including a first embodiment of a forward-reverse assembly 266 which may be incorporated into the box ratchet 10 described above with reference to FIGS. 5 and 6.

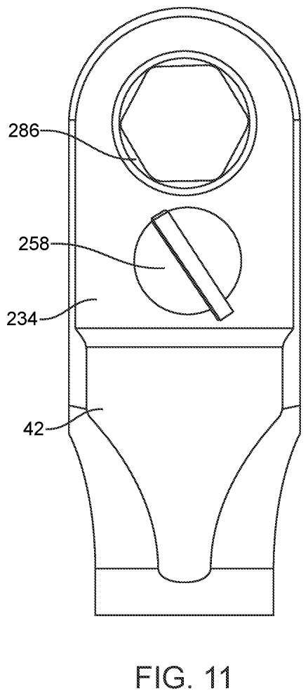

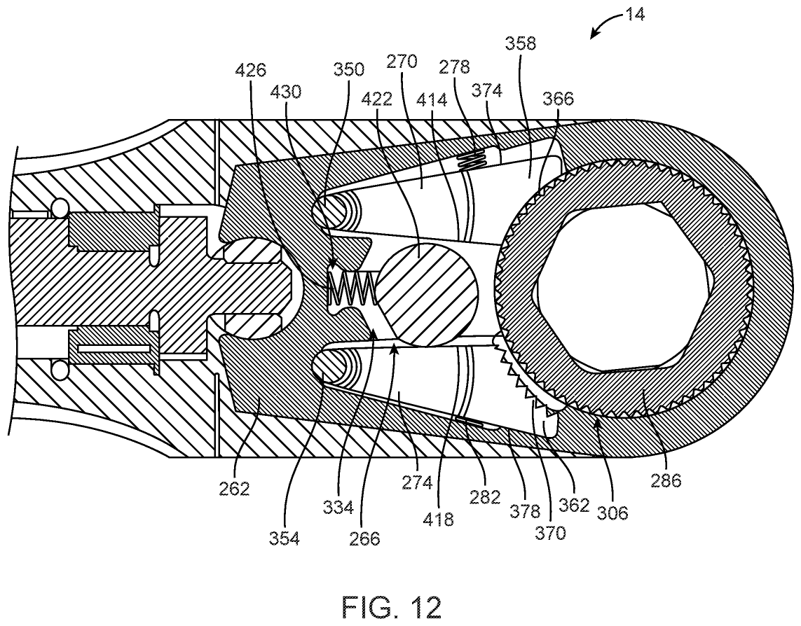

The ratchet assembly 14 includes a yoke 262, a forward-reverse assembly 266, a left pawl 270 and a right pawl 274, biasing members (e.g., first biasing member 278 and second biasing member 282), and a drive 286 with a splined outer periphery 290 that interfaces with the pawls 270, 274. The yoke 262 includes a cavity 334 that extends from the top face 338 of the yoke 262 that receives and supports the left and right pawls 270, 274, the forward-reverse assembly 266, and the first and second biasing members 278, 282 proximate the fastening hole 306. The left and right pawls 270, 274 of the present embodiment each include a substantially planar central portion 414, 418 extending from the coupling portion 350, 354 to the engagement portion 358, 362 (FIGS. 12, 14).

The forward-reverse assembly 266 is supported in the cavity 334 of the yoke 262 between the left and right pawls 270, 274. The forward-reverse assembly 266 is configured to selectively disengage the left or right pawl 270, 274 with the drive 286 for user selection of the operational direction (i.e., the tightening or loosening direction) of the ratchet assembly 14. The illustrated forward-reverse assembly 266 includes a shuttle 422 supported in the cavity 334 and rotatably coupled to the yoke 262, a biasing member 426 (e.g., a compression spring) supported in a recess 430 extending from the cavity 334, and a detent 434 (FIG. 11) biased toward the shuttle 422 by the biasing member 426.

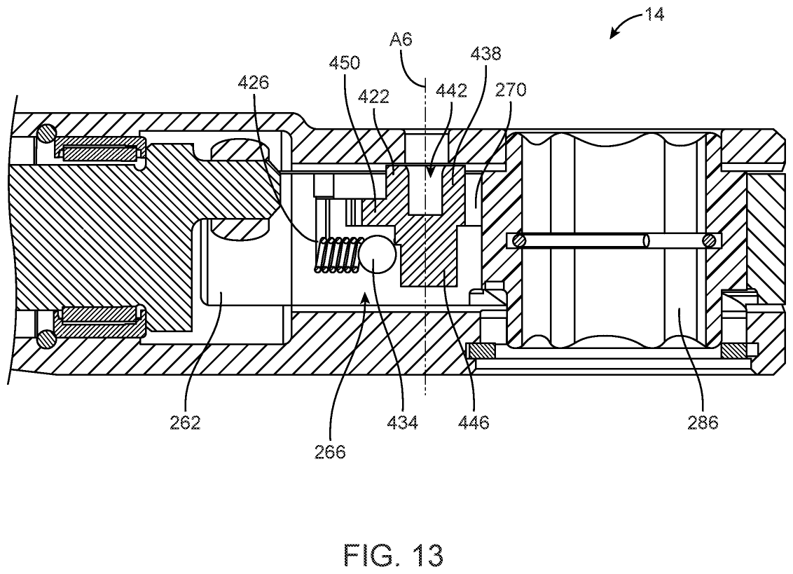

Referring to FIG. 13, the shuttle 422 includes a coupling portion 438 defining a bore 442 extending along a shuttle rotational axis A6 and a detent portion 446 that extends from and is coaxial with the coupling portion 438. The coupling portion 438 includes a lobe 450 extending radially outward from at least a portion of the circumference of the coupling portion 438 and adjacent to the detent portion 446. A directional knob 258 is coupled to the shuttle 422 via the bore 442 (e.g., in threaded connection). In some embodiments, the direction knob may be integrally formed with the shuttle 422 or coupled to the shuttle 422 in other ways to selectively rotate the shuttle 422.

The lobe 450 of the shuttle 422 has an arcuate profile (shown in FIG. 12) that is eccentric relative to the shuttle rotational axis A6, thereby defining a cam profile with a varying radius such that, in a first rotational position, the radius on one side is larger than the opposite side to allow one pawl (e.g., left pawl 270) to be engaged with the splined outer periphery 290 of the drive 286 while contact with the lobe 450 with the other pawl (e.g., right pawl 274) disengages the pawl from the drive 286. As shown in FIG. 12, the detent portion 446 includes a ridge 458 having an arcuate profile that is positioned between first and second indents 462, 466. The first and second indents 462, 466 each have an outer edge 470 that define rotational stops.

The detent 434 includes a rounded head 474 that defines a shoulder 478 adjacent the head 474, and a shaft portion 482 that extends from the shoulder 478 and into the biasing member 426, which biases the rounded head 474 into contact with the shuttle 422, in the first or second indents 462, 466, or the ridge 458, based on user selection.

A plate 484 is coupled to the yoke 262 (e.g., with fasteners, via a snap-fit engagement, or another manner) to retain the forward-reverse assembly 266 within the cavity 334 of the yoke 262.

Rotation of the directional knob 258 rotates the shuttle 422 about the shuttle rotational axis A6 from a first position to a second position. In the first position, the rounded head 474 is biased toward the shuttle 422 and thereby disposed in the first indent 462. As the user rotates the directional knob 258, the ridge 458 of the detent portion 446 is brought into contact with the rounded head 474, exerting a force on the detent 434 in a direction opposite the direction the biasing member 426 is exerting a biasing force on the detent 434. As the user continues to rotate the directional knob 258 and the contact point of the ridge 458 and the detent 434 approaches the midpoint of the ridge 458, the torque input required to rotate the directional knob 258 increases until the contact point is at the midpoint of the ridge 458. As the user continues to rotate the directional knob 258 toward the second position, the required torque input decreases until the directional knob 258 and shuttle 422 are in the second position, and the detent 434 is disposed in the second indent 466.

While the first and second positions are described as the position of the detent 434 relative to the first indent 462 and the second indent 466, respectively, the first position may instead refer to the position of the directional knob 258, shuttle 422, and detent 434 when the detent 434 is positioned in the second indent 466 and the second position may instead refer to the position of the directional knob 258, shuttle 422, and detent 434 when the detent 434 is positioned in the first indent 462. The first position may thus correspond to a position of the shuttle 422 in which the left pawl 270 is disengaged from the drive 286 and the right pawl 274 is engaged with the drive 286 and the second position may correspond to a position of the shuttle 422 in which the left pawl 270 is engaged with the drive 286 and the right pawl 274 is disengaged from the drive 286, or vise-versa.

It will be appreciated that the ratchet assembly 14 provides a distinct tactile indication to the user that the direction of operation of the ratchet assembly 14 has been changed upon rotation of the directional knob 258. The ratchet assembly 14 may further provide a distinct auditory indication in addition to the tactile indication.

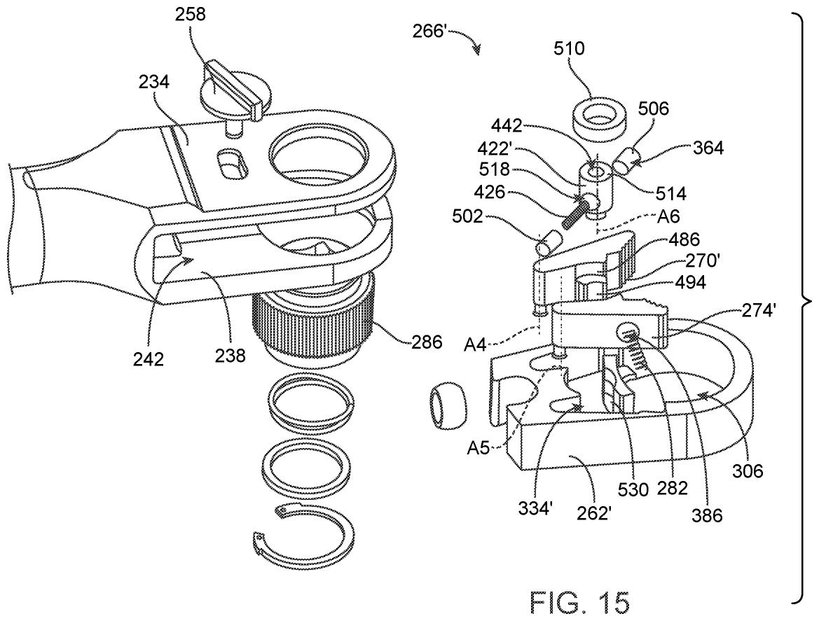

FIGS. 15-17 illustrate another embodiment of a ratchet assembly 14′ including a forward-reverse assembly 266′, or shuttle assembly. Except where otherwise described, operation of the ratchet assembly 14′ may be substantially the same as the operation of ratchet assembly 14 described above. Similar parts as the first embodiment having a different structure are designated with a prime (′) annotation. The ratchet assembly 14′ may be incorporated into the box ratchet 10 described above.

The ratchet assembly 14′ includes a yoke 262′, a forward-reverse assembly 266′, a left pawl 270′ and a right pawl 274′, biasing members (e.g., first biasing member 278 and second biasing member 282), and a drive 286, which, in the illustrated embodiment, includes a splined outer periphery 290 configured to interface with the pawls 270′, 274′.

The yoke 262′ includes a cavity 334′ that extends from the top face 338′ of the yoke 262′ and is configured to receive and support the left and right pawls 270′, 274′, the forward-reverse assembly 266′, and the first and second biasing members 278, 282 proximate the fastening hole 306.

The left pawl 270′ and right pawl 274′ are pivotally coupled to the yoke 262′, with each pawl 270′, 274′ rotatable about a pawl rotational axis (e.g., substantially similar to the first pawl rotational axis A4 and second pawl rotational axis A5, shown in FIG. 8) relative to the yoke 262′. Each of the left pawl 270′ and the right pawl 274′ define a coupling portion 350′, 354′ pivotally coupled to the yoke 262′ and an opposite engagement portion 358′, 362′ that defines pawl teeth 366′, 370′. A central portion 486, 490 positioned between the coupling portion 350′, 354′ and the engagement portion 358′, 362′ of the left and right pawls 270′, 274′ defines an engagement surface 494, 498 having a curved profile that is engageable by the forward-reverse assembly 266′. An outer wall 374′, 378′ extends between the coupling portions 350′, 354′ and the engagement portions 358′, 362′ of each of the left pawl 270′ and right pawl 274′ and includes a bore 382, 386 extending into the left and right pawls 270′, 274′.

The forward-reverse assembly 266′ is rotatably supported in the cavity 334′ of the yoke 262′ between and engages the left pawl 270′ and the right pawl 274′. The forward-reverse assembly 266′ includes a shuttle 422′ pivotally coupled to the yoke 262′, a biasing member 426′ (i.e., a shuttle biasing member) (e.g., a compression spring), an inner cap 502 and an outer cap 506, and a cover 510. The directional knob 258 is coupled to the shuttle 422′ for rotation with the forward-reverse assembly 266′.

The shuttle 422′ has a cylindrical body (i.e., a shuttle body) that has a top surface 514 with a bore 442 extending from the top surface 514 along the shuttle rotational axis A6. The directional knob 258 is coupled to the shuttle 422′ via the bore 442 for rotation of the forward-reverse assembly 266′ about the shuttle rotational axis A6 in response to rotation of the directional knob 258. A receiving hole 518 extends through the shuttle 422′ in a direction substantially perpendicular to the shuttle rotational axis A6. The biasing member 426′ is received in the receiving hole 518.

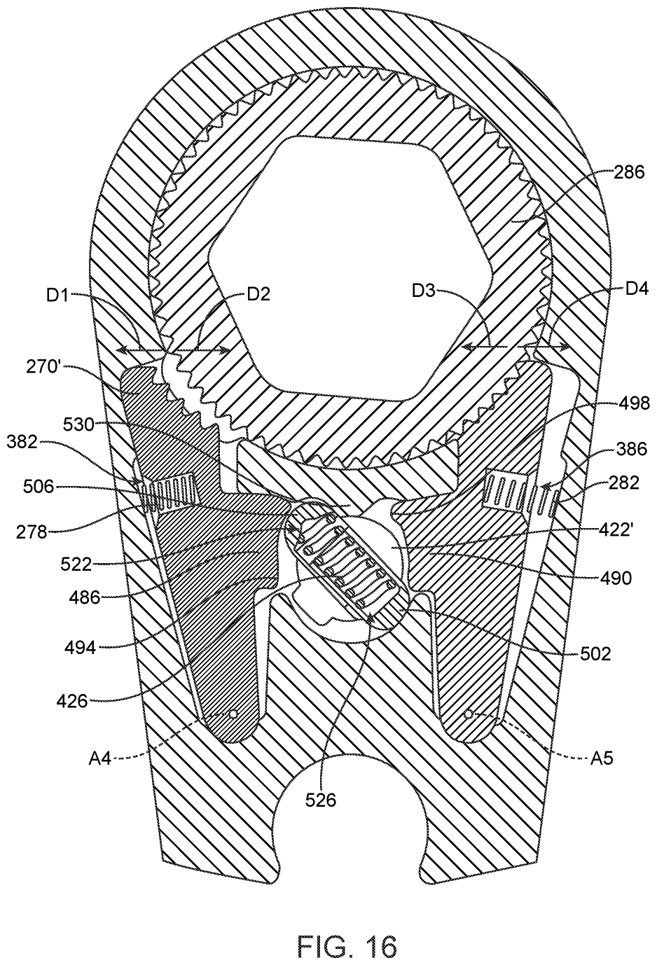

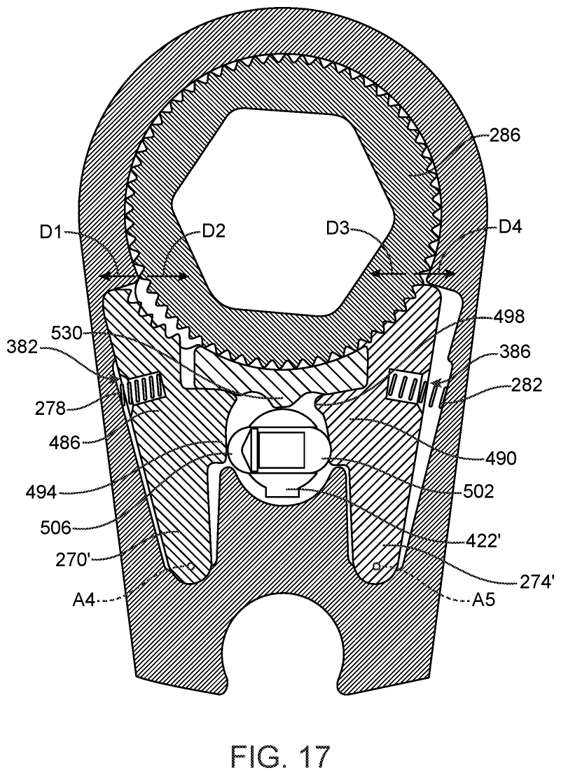

The inner cap 502 and outer cap 506 are disposed at least partially within the receiving hole 518. The inner cap 502 and outer cap 506 each define an interior bore 522, 526 in which the biasing member 426 is disposed such that the inner and outer cap 502, 506 surround and engage opposite ends of the biasing member 426. The inner cap 502 is at least partially nested within the outer cap 506 (FIGS. 16, 17) and the inner cap 502 and outer cap 506 are slidable relative to one another and to the body of the shuttle 422′. The inner cap 502 and outer cap 506 selectively engage the engagement surfaces 494, 498 of the left and right pawls 270′, 274′. The yoke 262′ defines a rotational stop 530 that is selectively engageable by the inner and outer caps 502, 506 and defines first rotational position (FIG. 16) and second rotational positions (not shown) of the forward-reverse assembly 266′. Engagement of the inner and outer caps 502, 506 with the rotational stop 530 defines a rotational range between the first position and second position. The rotational range defines a maximum angle of rotation of the forward-reverse assembly and the forward-reverse assembly is prevented from rotating through an angle greater than the rotational range. In some embodiments, the rotational range is about 30 degrees. In other embodiments, the rotational range may be another angle, for instance, 45 degrees, 60 degrees, or 90 degrees.

The cover 510 has an annular, or ring, profile and is supported in the cavity 334′ and circumferentially surrounds at least a portion of the body of the shuttle 422′ thereby maintaining the position of the shuttle 422′ within the cavity 334′.

With continued reference to FIGS. 15-17, interaction of the forward-reverse assembly 266′ and other components of the ratchet assembly 14′ will be described in greater detail. The first and second biasing members 278, 282 and the biasing member 426 (third biasing member) of the forward-reverse assembly 266′ interact to engage and disengage the left and right pawls 270′, 274′ with the splined outer periphery 290 of the drive 286. The first biasing member 278 biases the left pawl 270′ toward the drive 286 and imparts a first moment on the left pawl 270′ in a first direction D1 (toward the drive 286) about the left pawl rotational axis A4. The second biasing member 282 biases the right pawl 274′ toward the drive 286 and imparts a first moment on the right pawl 274′ in a first direction D3 (toward the drive 286) about the right pawl rotational axis A5. The third biasing member 426 selectively applies a force to the engagement surface 494, 498 of the left pawl 270′, right pawl 274′, or both left and right pawls 270′, 274′. When the outer cap 506 engages the engagement surface 494 of the left pawl 270′, the third biasing member 426 imparts a second moment on the left pawl 270′ in a second direction D2 (away from the drive 286) opposite the first direction D1 about the left pawl rotational axis A4. When the inner cap 502 engages the engagement surface 498 of the right pawl 274′, the third biasing member 426 imparts a second moment on the right pawl 274′ in a second direction D4 (away from the drive 286) opposite the first direction D3 about the right pawl rotational axis A5. As shown in FIG. 17, the inner and outer caps 502, 506 may simultaneously engage the engagement surfaces 494, 498 of the left and right pawls 270′, 274′ thereby imparting second moments on both the left and right pawls 270′, 274′.

Returning to FIG. 16, an exemplary first position of the forward-reverse assembly 266′ in relation to the yoke 262′ is illustrated. In the first position, the forward-reverse assembly 266′ is positioned such that the outer cap 506 engages the rotational stop 530 of the yoke 262′ and the engagement surface 494 of the left pawl 270′. The second position (not shown) is achieved when the inner cap 502 engages the rotational stop 530 and the engagement surface 498 of the right pawl 274′. In other embodiments, the first position may be defined as the position at which the inner cap 502 engages the rotational stop 530 and the position of the forward-reverse assembly 266′ illustrated in FIG. 7 represents a second position of the forward-reverse assembly 266.

As illustrated in FIG. 16, the forward-reverse assembly 266′ is positioned at the first rotational position (via the directional knob 258) to bias the left pawl 270′ out of engagement with the drive 286. The third biasing member 426 imparts a second moment on the left pawl 270′ via the outer cap 506 that is greater than the first moment imparted by the first biasing member 278, resulting in the left pawl 270′ being biased away from the drive 286. In the first rotational position of the forward-reverse assembly 266′, the inner cap 502 engages the yoke 262′ and the third biasing member 426 does not impart a second moment on the right pawl 274′. The second biasing member 282 imparts a first moment on the right pawl 274′, biasing the right pawl 274′ into engagement with the drive 286.

With reference to FIG. 17, as the directional knob 258 (shown in FIG. 15) and the forward-reverse assembly 266′ are rotated to an intermediate position between the first position and the second position, the inner cap 502 is brought into engagement with the engagement surface 498 of the right pawl 274′ while the outer cap 506 continues to engage the engagement surface 494 of the left pawl 270′. The third biasing member 426 continues to impart a second moment on the left pawl 270′ that is greater than the first moment applied by the first biasing member 278, biasing the left pawl 270′ out of engagement with the drive 286. The third biasing member 426 also imparts a second moment on the right pawl 274′ as the inner cap 502 contacts the engagement surface 498 of the right pawl 274′. As a result of operation of the tool 10, a frictional force and resulting moment are also imparted by the drive 286 to the right pawl 274′. The combination of the first moment exerted by the second biasing member 278 and the frictional moment of the drive 286 on the right pawl 274′ is in the first direction D3 toward the drive 286 is greater than the moment of the second biasing member 282 on the right pawl 274′. The right pawl 274′, therefore, continues to engage the drive 286 until the drive 286 or ratchet assembly 14′ are rotated, thereby relieving the frictional force and resulting moment of the drive 286 on the right pawl 274′. The second moment applied by the third biasing member 426 on the right pawl 274′ is greater than the first moment of the second biasing member 282 on the right pawl 274′, resulting in disengagement of the right pawl 274′ from the drive 286 once the frictional force of the drive 286 on the right pawl 274′ is relieved. As the directional knob 258 continues to be rotated to the second position (opposite from the first position of FIG. 16), the outer cap 506 will disengage the engagement surface 494 of the left pawl 270′ thereby removing the second moment from the left pawl 270′ and allowing the first moment from the first biasing member 278 to bias the left pawl 270′ into engagement with the drive 286.

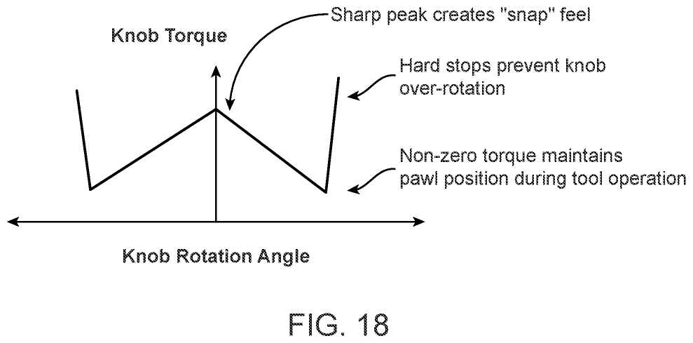

With reference to FIG. 18, a graph showing the torque applied to the knob as a result of rotational angle of the directional knob is shown. The illustrated graph is one embodiment illustrating the torque vs. angle curve and other embodiments of the graph are possible. In operation, as the directional knob 258 is rotated between the first position and the second position, the torque required to be applied by the user to rotate the directional knob 258 will vary depending on the angular position of the directional knob 258. As the directional knob 258 is rotated from the first position, the torque required will decrease from a peak torque to a minimum torque, increase from the minimum torque to an intermediate torque at the middle of the rotational angle, decrease again to a minimum torque, and then increase to the peak torque as the directional knob 258 reaches the second position.

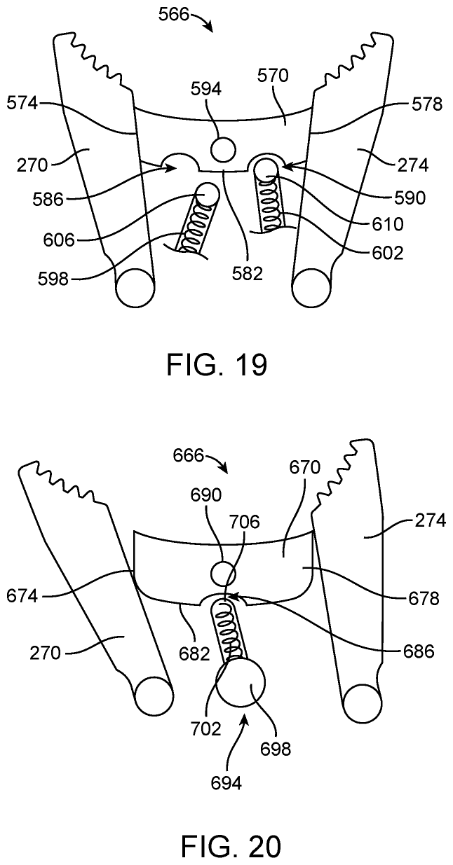

FIGS. 19-22 illustrate additional embodiments of a forward-reverse assembly of a ratchet assembly.

In one embodiment, illustrated in FIG. 19, the forward-reverse assembly 566 includes a shuttle 570 disposed in the yoke (not shown) between the left and right pawls 270, 274. The shuttle 570 defines cam surfaces 574, 578 at opposite ends of a first surface 582 and a pair of recesses 586, 590 defined in a first surface 582 between the cam surfaces 574, 578. The shuttle 570 is pivotable about a pivot point 594 defined in the shuttle 570 which may be coupled to the directional knob 258. The forward-reverse assembly 566 also includes a pair of biasing members 598, 602 and a pair of detents 606, 610 that are biased toward, and are selectively disposed in the recesses 586, 590. As the shuttle 570 is rotated, one of the cam surfaces 574, 578 engages the left or right pawl 270, 274 thereby disengaging the pawl from the drive 286 and the other cam surface 574, 578 is disengaged from the other pawl 270, 274, allowing the pawl to engage the drive 286. When the shuttle 570 is rotated to a first position at which a first cam surface (e.g., the cam surface on the left side of the shuttle 570, as viewed in FIG. 19) engages one of the pawls (e.g., the left pawl 270), one of the detents 606, 610 (e.g., the right detent 610 as viewed in FIG. 19) is disposed in the corresponding recess (e.g., recess 590). As the shuttle 570 is rotated to the opposite second position, the first detent is removed from the corresponding recess and the second detent is disposed in the corresponding second recess.

In another embodiment, illustrated in FIG. 20, the forward-reverse assembly 666 includes a shuttle 670 disposed in the yoke (not shown) between the left and right pawls 270, 274. The shuttle 670 defines cam surfaces 674, 678 at opposite ends of a first surface 682 and a recess 686 defined in the first surface 682 between the cam surfaces 674, 678. The shuttle 670 is pivotable about a pivot point 690 defined in the shuttle 670. A switching structure 694 is also disposed in the yoke between the left and right pawls 270, 274 and is rotatable relative to the yoke. The switching structure 694 includes a body 698 coupled to the directional knob 258, a biasing member 702 and a detent 706 that extend therefrom. The detent 706 is disposed in the recess 686 and engages the shuttle 670. As the switching structure 694 is rotated, the biasing member 702 imparts a force on the detent 706 which applies a force to the shuttle 670. Rotation of the switching structure 694 imparts a force on the shuttle 670 that rotates the shuttle 670 such that one of the cam surfaces 674, 678 engages one of the pawls (e.g., the left pawl 270) and biases the pawl out of engagement with the drive 286 while allowing the other pawl (e.g., right pawl 274) to engage the drive 286 and rotate the drive 286 to loosen or tighten a fastener. Rotating the switching structure 694 in the opposite direction and resulting sliding engagement of the detent 706 with the shuttle 670 causes rotation of the shuttle 670 which disengages the other pawl (e.g., the right pawl) from the drive 286 and allows the first pawl (e.g., the left pawl) to engage the drive 286.

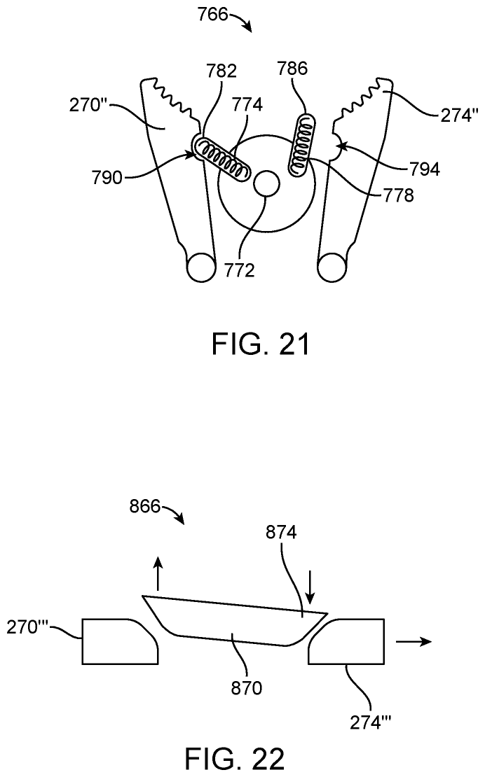

In yet another embodiment, illustrated in FIG. 21, the forward-reverse assembly 766 is disposed in the yoke (not shown) between the left and right pawls 270″, 274″. The forward-reverse assembly 766 includes a shuttle 770 that is rotatable about a pivot 772 defining an eccentric shuttle rotation axis A6 from which a pair of biasing members 774, 778 extend which engage detents 782, 786. The left and right pawls 270″, 274″ each define a recess 790, 794 that is selectively engageable by one of the detents 782, 786. As the forward-reverse assembly 766 is rotated about the shuttle rotation axis A6, one of the left and right pawls 270″. 274″ is engaged by the one of the detents 782, 786 and the corresponding biasing member 774, 778 imparts a force on the corresponding pawl 270″, 274″ to bias the pawl out of engagement with the drive (not shown). The other biasing member and detent are concurrently disengaged from the recess of the pawl allowing the pawl to engage the drive.

In yet another embodiment, illustrated in FIG. 22, the forward-reverse assembly 866 includes a shuttle 870 that is disposed between the pawls 270′″, 274′″. As the shuttle 870 is rotated, a first end 874 (e.g., the right end as illustrated in FIG. 22) engages the corresponding pawl (e.g., the left pawl 270′″) thereby biasing the pawl out of engagement with the drive (not shown), while allowing the other pawl to engage the drive.

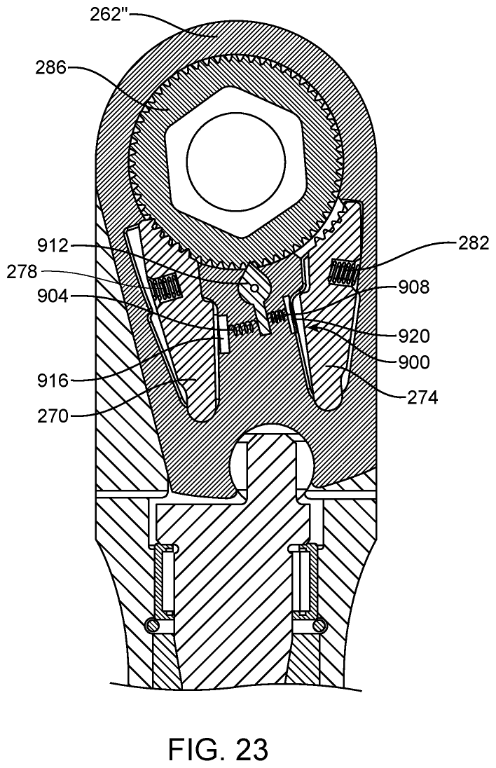

In another embodiment of the ratchet assembly 14″, illustrated in FIG. 23, the ratchet assembly 14″ includes an idler assembly 900 in place of the friction plate 326 to limit backward rotation of, and maintain the position of, the drive 286. The idler assembly 900 includes a pair of biasing members 904, 908 and an idler pawl 912 that engages the drive 286. The idler pawl 912 is rotatably supported in the yoke 262″ and the pair of biasing members 904, 908 each engage an opposite side of the idler pawl 912 and apply opposing biasing forces on the idler pawl 912. The biasing members 904, 908 may be coupled to plates 916, 920 opposite the idler pawl 912.

FIGS. 24A-D illustrate embodiments of exemplary accessories (e.g., sockets 930a, 930b, 930c and a bit adapter 930d) having a coupling portion 934 configured to be received in the insertion hole 394 of the drive 286. In the present embodiments, the coupling portion 934 is illustrated as having a hexagonal cross-sectional profile, however other cross-sectional profiles may be used instead. An adapter portion 938a-d extends from the coupling portion 934. In a first embodiment of an accessory illustrated in FIG. 24A, the socket 930a has an adapter portion 938a that defines a recess 942 having a hexagonal cross-section configured to receive a hexagonal head of a fastener, although the recess 942 could receive other fastener heads such as appropriately sized square and Torx heads. In other embodiments, the recess 942 may have other cross-sectional profiles. In one embodiment, the recess may have a cross-section that is a twelve-point double hexagon. In another embodiment of an accessory, illustrated in FIG. 24B, the socket 930b has a pass-through hole 946 that extends along and through the coupling portion 934. In another embodiment of an accessory, illustrated in FIG. 24C, the socket 930c has a hexagonal recess 950 that is smaller than the cross-sectional area of the coupling portion 934 of the socket 930c. In another embodiment of an accessory, illustrated in FIG. 24D, the adapter 930d includes an adapter portion 938d that defines a square cross-section and include a detent 958 (e.g., a ball) supported in the adapter portion 938d. A tool bit, such as a socket (not shown) having a recess with a square cross-sectional area substantially the same as the adapter portion 938d, can receive the adapter portion 938d and the socket remains coupled to the adapter portion 938d via the detent 958. The exemplary accessories include a groove 962 in the coupling portion 934 that receives the accessory retention spring 402. In other embodiments, illustrated in FIGS. 24E and 24F, an accessory (e.g., socket 930c) may have two grooves 962 spaced along the coupling portion 934′. As shown in FIG. 24F, the accessory (e.g., socket 930f) includes two grooves 962 and a pass-through hole 946 extends along and through the coupling portion 934. The pass-through hole 946 may allow a length of threaded rod to extend through the accessory 930f. Embodiments of accessories are to be understood as exemplary embodiments and other embodiments of accessories may be coupled to the tool 10.

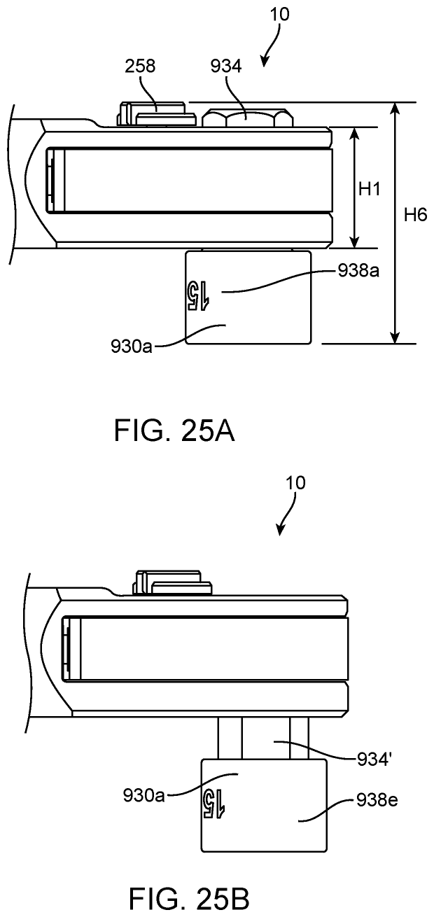

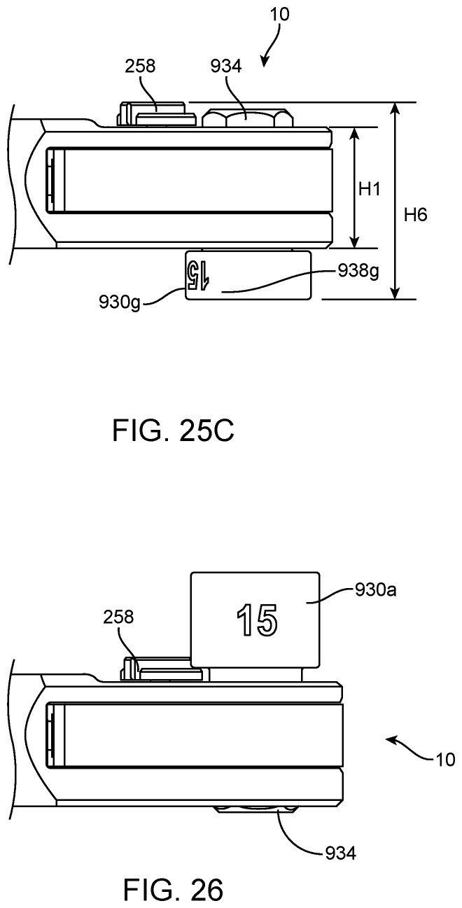

As shown in FIGS. 25A, 25B, and 26, any of the above accessories (e.g., socket 930a) may be inserted into the drive 286 from either the top (shown in FIG. 25A) or the bottom (shown in FIG. 26). Accessories having a larger diameter (e.g., larger sockets, for instance a socket for a hex head fastener having a 21 mm head) may contact the directional knob 258. An accessory inserted from the bottom defines a first insertion direction and an accessory inserted from the top defines a second insertion direction. In either insertion direction, the coupling portion may project beyond the upper or lower flanges. When the accessory is inserted in the first direction, the accessory retention spring 402 is received in the groove 962. When the accessory is inserted in the second direction, however, the accessory retention spring 402 is not received in the groove 962. It will be appreciated by one skilled in the art that the alignment of the accessory retention spring 402 with the groove 962 provides a tactile indication of complete insertion of the accessory while maintaining the accessory in the drive.

As illustrated in FIGS. 24E and 25B, for an accessory having two grooves, (e.g., socket 930e), the accessory may be inserted in either the first or second direction and the first groove 962 receives the accessory retention spring 402. When the first groove receives the accessory retention spring 402, the accessory is at a position that provides additional reach, that is, facilitates engagement of the accessory with a fastener that is recessed below an adjacent surface. When the accessory is inserted in the first direction (i.e., from the bottom of the tool), the accessory may be further inserted such that the second groove receives the accessory retention spring 402 and the accessory is fully inserted. As shown in FIG. 24E, when the accessory is inserted in the second direction and the first groove receives the accessory retention spring 402, the adapter portion 938e does not contact the directional knob 258. As illustrated in FIG. 26, as the accessory continues to be inserted in the second direction and the first groove passes the accessory retention spring 402, the adapter portion 938e may contact the directional knob 258.

In order to eject the accessory, the user can press on the portion of the coupling portion 934 that is exposed on the opposite side of the tool 10 or grasp the adapter portion 938a-e and pull the accessory from the tool 10.

Returning with reference to FIGS. 5 and 9, the dimensions of the tool 10 are optimized to apply the proper torque to a fastener while minimizing the width of the tool 10, in particular, the width W of the ratchet portion 230 of the yoke housing 42 to be able to access fasteners that are disposed in a location that would otherwise be difficult to reach with a larger tool. It will be appreciated by those skilled in the art that an accessory with smaller wall thickness allows the size of the tool to be reduced thus allowing the user to access fasteners in more confined spaces, however, if the size of the accessory is too small, the tool 10 will not be able to apply the proper torque to a fastener via the accessory. For a larger accessory, the size of the tool 10 generally increases to accommodate the larger accessory size. In the present embodiment, the fastening hole 306 of the drive 286 has a flat-to-flat width H5 of 14.19 millimeters and the diameter of a circumscribed circle (i.e., a circle that contacts each point of the hexagonal fastening hole 306 has a diameter of 16.385 millimeters and the tool has a width of 30 millimeters.

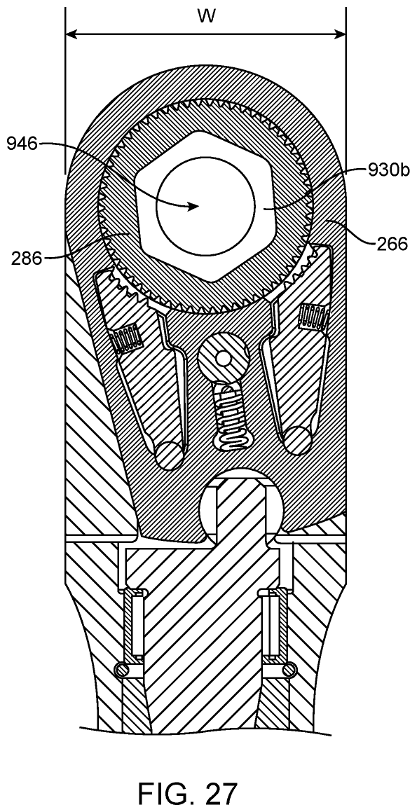

With reference to FIG. 27, for embodiments of an accessory having a pass-through hole 946 (e.g., socket 930b), the accessory and tool sizing are dependent, as well, on the diameter of the pass-through hole 946. The pass-through hole 946 allows a rod (e.g., threaded rod) to pass though the accessory. It will be appreciated that the larger the pass-through, the narrower the wall thickness of the accessory, and therefore, the lower the torque that the tool could apply to a fastener through the accessory. In the present embodiment, for a tool having a width W of 30 millimeters, the diameter of the pass-through hole 946 is 10.5 millimeters, which can accommodate the threaded rod for a fastener having a head diameter of 15 millimeters (e.g., an M10 fastener).

Returning with reference to FIG. 25A, the height of the adapter portion (e.g., adapter portion 938a-c) of the accessory (e.g., sockets 930a-c) is sized to access fasteners where space above the fastener head is limited while maintaining sufficient height of the adapter portion. It will be appreciated by those skilled in the art that those competing considerations (i.e., space to access the fastener, adapter potion height to engage the fastener) affect the height of the adapter portion and the overall height of the tool 10. For instance, a shorter height allows access to fasteners with limited spaced, but may not provide sufficient reach for longer fasteners. However, an adapter with a longer adapter portion may have sufficient length but would not be able to reach fasteners with little space. The accessory of the present embodiment is sized such that the height H6 of the accessory and tool 10 (e.g. the distance from the directional knob 258 to the end of the adapter portion, e.g., 938a, of the socket 930b) is approximately 41.74 millimeters. The accessory may have other heights that are optimized for different applications. For instance an accessory with a recess 942 sized to receive a 21 millimeter hex may have a height that is less than 43.5 millimeters. In an embodiment where an adapter (e.g., adapter 930d) is coupled to the tool 10, the total height of the tool may be, for instance, less than 39 millimeters.

With the accessory inserted into the drive 286, the tool 10 and accessory together define a total height H6. The ratio of the total height H6 (i.e., when the accessory is attached to the tool 10) to the ratchet height H1 is greater than 1.75:1. In other embodiments, illustrated for instance in FIG. 25C, an accessory (e.g., socket 930g) having a shorter adapter portion 938g (a “stubby” or “super stubby” socket) may have a ratio of total height H6 to ratchet height H1 of about 1.2:1. Other ratios may be used instead.

The tool 10 of any of the previously described embodiments is configured such that it is capable of applying a fastening torque (i.e., when a user applies a torque with the tool 10 while the switch 58 is released and the motor 82 is not turning the drive 286) between approximately 120 foot-pounds and 250 foot-pounds, for instance, a fastening torque of 150 foot-pounds.

Although the disclosure has been described in detail with reference to certain preferred embodiments, variations and modifications exist within the scope and spirit of one or more independent aspects of the disclosure as described.

### Representative Features

Representative features are set out in the following clauses, which stand alone or may be combined, in any combination, with one or more features disclosed in the text and/or drawings of the specification.

Clause 1. A ratchet assembly configured to rotate a fastener in both a clockwise and a counterclockwise direction, the ratchet assembly comprising: a yoke defining a fastening hole; a drive rotatably coupled to the yoke and supported in the fastening hole; a left pawl supported in the yoke and biased toward the drive by a first biasing member; a right pawl supported in the yoke and biased toward the drive by a second biasing member; a shuttle assembly rotatably supported in the yoke between the left pawl and the right pawl; and a directional knob coupled to the shuttle assembly.

Clause 2. The ratchet assembly of clause 1, wherein the shuttle assembly includes a shuttle body, a shuttle biasing member supported in the shuttle body, an inner cap and an outer cap supported in the shuttle body, the shuttle biasing member biasing the inner cap away from the outer cap.

Clause 3. The ratchet assembly of clause 2, wherein the yoke defines a rotational stop, the shuttle assembly selectively engaging the rotational stop to prohibit rotation of the shuttle assembly about an angle greater than 30 degrees.

Clause 4. The ratchet assembly of clause 1, wherein the drive includes spline teeth, the left pawl and the right pawl each define a coupling portion pivotally coupled to the yoke, an engagement portion defining pawl teeth selectively engageable with the spline teeth, and a central portion defining an engagement surface engageable with the shuttle assembly.

Clause 5. The ratchet assembly of clause 1, wherein the left pawl and the right pawl each define a bore, the first biasing member and second biasing member are disposed in the bore of the left pawl and the right pawl and engage an outer wall of the yoke.

Clause 6. The ratchet assembly of clause 1, wherein the fastening hole defines a fastening axis, wherein the shuttle assembly is rotatable about a shuttle axis parallel to the fastening axis, and wherein the shuttle assembly includes an engagement portion with an arcuate outer surface that is eccentric relative to the shuttle axis.

Clause 7. The ratchet assembly of clause 6, wherein engagement between the arcuate outer surface and the left pawl moves the left pawl out of engagement with the drive in response to rotation of the shuttle assembly in a first direction, and wherein engagement between the arcuate outer surface and the right pawl moves the right pawl out of engagement with the drive in response to rotation of the shuttle assembly in a second direction.

Clause 8. The ratchet assembly of clause 1, 4, 5, 6, or 7, wherein the shuttle assembly includes a detent portion having a first indent, a second indent, and a ridge between the first indent and the second indent, and wherein the ratchet assembly further comprises a detent biased into engagement with the detent portion and having a rounded head received within the first indent when the shuttle assembly is in a first position corresponding with the left pawl being moved out of engagement with the drive, and wherein the rounded head is received within the second indent when the shuttle assembly is in a second position corresponding with the right pawl being moved out of engagement with the drive.

Clause 9. A ratchet assembly comprising: a spline; a pawl selectively frictionally engaged with the spline, the spline imparting a frictional moment on the pawl in a first direction about a pawl rotational axis; a first biasing member biasing the pawl into engagement with the spline and imparting a first moment on the pawl in the first direction about the pawl rotational axis; and a second biasing member biasing the pawl out of engagement with the spline and imparting a second moment on the pawl in a second direction opposite the first direction about the pawl rotational axis.

Clause 10. The ratchet assembly of clause 9, wherein the second moment is greater than the first moment.

Clause 11. The ratchet assembly of clause 9, wherein a combination of the first moment and the frictional moment is greater than the second moment.

Clause 12. The ratchet assembly of clause 10, wherein rotation of the spline relieves the frictional moment on the pawl allowing disengagement of the pawl with the spline.

Clause 13. The ratchet assembly of clause 9, further comprising a directional knob coupled to the second biasing member and configured to receive a torque applied by a user, the directional knob rotatable about a rotation angle between a first position and an opposite second position in response to the torque applied to the directional knob, the torque required to rotate the directional knob from the first position to the second position decreasing from a peak torque to a minimum torque, increasing from the minimum torque to an intermediate torque at a middle of the rotation angle, decreasing to the minimum torque, and then increasing to the peak torque as the directional knob reaches the second position.

Clause 14. The ratchet assembly of clause 9, wherein the pawl is a first pawl, the ratchet assembly further comprising a second pawl selectively frictionally engaged with the spline, the spline imparting a frictional moment on the second pawl in a first direction about a second pawl rotational axis, a third biasing member biasing the second pawl into engagement with the spline and imparting a first moment on the second pawl in the first direction about the second pawl rotational axis, the second biasing member biasing the second pawl out of engagement with the spline and imparting a second moment on the second pawl in a second direction opposite the first direction about the second pawl rotational axis, the second moment on the second pawl is greater than the first moment on the second pawl, and a combination of the frictional moment on the second pawl and the first moment on the second pawl is greater than the second moment on the second pawl.

Clause 15. A ratchet tool comprising: a housing including a drive housing in which a motor is supported and a yoke housing extending from the drive housing; a crankshaft coupled to the motor and rotatable therewith about a crankshaft axis, the crankshaft at least partially supported in the yoke housing and including a coupling portion having a coupling axis radially offset from the crankshaft axis; a ratchet assembly pivotally coupled to the yoke housing and operably engaged to the coupling portion, the ratchet assembly including a yoke, a first pawl and a second pawl pivotably coupled to the yoke, a drive rotatably supported in the yoke between the first pawl and the second pawl, and a first biasing member and a second biasing member, each of the first biasing member and the second biasing member engaging the first pawl and the second pawl to bias the first pawl and the second pawl into engagement with the drive.

Clause 16. The ratchet tool of clause 15, wherein the ratchet assembly is pivotable relative to the yoke housing about a fastening axis, the fastening axis perpendicular to the crankshaft axis.

Clause 17. The ratchet tool of clause 15, further comprising a bearing coupled to the coupling portion and engaging the yoke.

Clause 18. The ratchet tool of clause 15, wherein the first pawl and the second pawl each include a tooth portion defining a plurality of teeth, the drive defines a plurality of spline teeth, the teeth of the first pawl and the teeth of the second pawl engageable with the spline teeth, the tooth portion of the first pawl or the second pawl advancing circumferentially about the drive by two or more spline teeth as a result of one revolution of the crankshaft.

Clause 19. The ratchet tool of clause 15, wherein the drive defines an insertion hole configured to receive a coupling portion of an accessory, the accessory including an adapter portion extending from the coupling portion.

Clause 20. The ratchet tool of clause 19, wherein the adapter portion defines a recess configured to receive a fastener, the recess having a cross-section defining a hexagon or a 12 point double hexagon.

Clause 21. The ratchet tool of clause 20, wherein the recess defines a cross-sectional area less than a cross-sectional area of the adapter portion.

Clause 22. The ratchet tool of clause 19, wherein the coupling portion defines a pass-through hole extending along an axis of the coupling portion.

Clause 23. The ratchet tool of clause 19, wherein the adapter portion defines a square profile and includes a detent.

Clause 24. A ratchet tool comprising: a battery; a motor powered by the battery; and an accessory having a pass-through hole, wherein the pass-through hole is configured to receive a fifteen-millimeter-fastener that includes a threaded rod portion having a diameter greater than ten millimeters.

Clause 25. A ratchet tool comprising: a battery; a motor powered by the battery; a ratchet portion including an upper flange and a lower flange, the upper flange and the lower flange defining a tool height therebetween, a drive supported in the ratchet portion, and an accessory coupled to the drive, the accessory having a coupling portion that projects beyond the upper flange of the ratchet portion when the accessory is inserted in a first direction, the tool and the accessory defining a total height when the accessory is coupled to the tool, wherein the accessory can be reversed and inserted in a second direction such that the coupling portion projects beyond the lower flange of the ratchet portion, wherein the drive has an accessory retention spring that is received in a groove in the accessory only when the accessory is inserted from either the first direction or the second direction, and wherein a ratio of the total height when the accessory is attached to the tool to the tool height is greater than 1.75:1.

Clause 26. A ratchet tool comprising: a battery; a motor powered by the battery; a drive defining a fastening hole, the fastening hole defining a circumscribed circle having a diameter of less than 16.5 millimeters, the drive rotatable about a fastening axis; and a left pawl and a right pawl supported adjacent the drive, the left pawl and the right pawl each defining a plurality of teeth, the left pawl and the right pawl pivotable about a pawl rotational axis, and a distance between the pawl rotational axis and the fastening axis is as least 25 millimeters.

Clause 27. The ratchet tool of clause 26, wherein the tool is capable of applying a torque to a fastener that is between 120 ft-lbs. and 250 ft-lbs.

Clause 28. The ratchet tool of clause 26, wherein the left pawl and the right pawl each define five teeth.

Clause 29. A ratchet assembly configured to rotate a fastener in both a clockwise and a counterclockwise direction, the ratchet assembly comprising: a yoke defining a fastening hole; a drive rotatably coupled to the yoke and supported in the fastening hole; a pawl supported in the yoke and biased toward the drive by a biasing member; a shuttle assembly rotatably supported in the yoke and engaging the pawl; and a directional knob coupled to the shuttle assembly.

Clause 30. The ratchet assembly of clause 29, wherein the pawl is a first pawl, the biasing member is a first biasing member, the ratchet assembly further comprises a second pawl supported in the yoke and biased toward the drive by a second biasing member, and the shuttle assembly is rotatably supported in the yoke between the first pawl and the second pawl.

Clause 31. A ratchet assembly configured to rotate a fastener in both a clockwise and a counterclockwise direction, the ratchet assembly comprising: a yoke; a drive supported in the yoke and rotatable about a fastening axis; and a pawl supported in the yoke and pivotable about a rotational axis, the rotational axis and the fastening axis defining a line therebetween, wherein a center-to-center distance is defined between the fastening axis and the rotational axis, a pawl distance is defined between the rotational axis and the drive along the line, and a ratio of the pawl distance to the center-to-center distance is greater than 0.25.

Various features of the disclosure are set forth in the following claims.

What is claimed is:

1. A ratchet assembly configured to rotate a fastener in both a clockwise and a counterclockwise direction, the ratchet assembly comprising:
a yoke defining a fastening hole;
a drive rotatably coupled to the yoke and supported in the fastening hole;
a first pawl supported in the yoke and biased toward the drive by a first biasing member;
a second pawl supported in the yoke and biased toward the drive by a second biasing member;
a shuttle assembly rotatably supported in the yoke between the first pawl and the second pawl; and
a directional knob coupled to the shuttle assembly.

2. The ratchet assembly of claim 1, wherein the drive includes spline teeth, the first pawl and the second pawl each define a coupling portion pivotally coupled to the yoke, an engagement portion defining pawl teeth selectively engageable with the spline teeth, and a central portion defining an engagement surface engageable with the shuttle assembly.

3. The ratchet assembly of claim 1, wherein the first pawl and the second pawl each define a bore accommodating a respective one of the first biasing member and the second biasing member.

4. The ratchet assembly of claim 1, wherein the fastening hole defines a fastening axis, wherein the shuttle assembly is rotatable about a shuttle axis parallel to the fastening axis.

5. The ratchet assembly of claim 4, wherein the shuttle assembly includes an engagement portion with an arcuate outer surface that is eccentric relative to the shuttle axis such that the arcuate outer surface defines a cam profile.

6. The ratchet assembly of claim 5, wherein engagement between the arcuate outer surface and the first pawl moves the first pawl out of engagement with the drive in response to rotation of the shuttle assembly in a first direction, and wherein engagement between the arcuate outer surface and the second pawl moves the second pawl out of engagement with the drive in response to rotation of the shuttle assembly in a second direction.

7. The ratchet assembly of claim 6, wherein the shuttle assembly includes a detent portion having a first indent, a second indent, and a ridge between the first indent and the second indent, and wherein the ratchet assembly further comprises a detent biased into engagement with the detent portion.

8. The ratchet assembly of claim 7, wherein the detent includes a head received within the first indent when the shuttle assembly is in a first position corresponding with the first pawl being moved out of engagement with the drive, and wherein the head is received within the second indent when the shuttle assembly is in a second position corresponding with the second pawl being moved out of engagement with the drive.

9. The ratchet assembly of claim 4, wherein the first pawl is pivotable about a rotational axis, wherein a center-to-center distance is defined between the fastening axis and the rotational axis, wherein a pawl distance is defined between the rotational axis and an outer periphery of the drive, and wherein a ratio of the pawl distance to the center-to-center distance is greater than 0.25.

10. The ratchet assembly of claim 1, wherein the fastening hole defines a circumscribed circle having a diameter of less than 16.5 millimeters.

11. A ratchet tool comprising:
a housing including a drive housing in which a motor is supported and a yoke housing extending from the drive housing;
a crankshaft coupled to the motor and rotatable therewith about a crankshaft axis, the crankshaft at least partially supported in the yoke housing and including a coupling portion having a coupling axis radially offset from the crankshaft axis;
a ratchet assembly pivotally coupled to the yoke housing and operably engaged to the coupling portion, the ratchet assembly including
a yoke,
a first pawl and a second pawl pivotably coupled to the yoke,
a drive rotatably supported in the yoke between the first pawl and the second pawl, and
a first biasing member biasing the first pawl into engagement with the drive, and
a second biasing member biasing the second pawl into engagement with the drive.

12. The ratchet tool of claim 11, wherein the ratchet assembly is pivotable relative to the yoke housing about a fastening axis, the fastening axis perpendicular to the crankshaft axis.

13. The ratchet tool of claim 11, further comprising a bearing coupled to the coupling portion and engaging the yoke.

14. The ratchet tool of claim 11, wherein the first pawl and the second pawl each include a tooth portion having a plurality of teeth, wherein the drive includes a plurality of spline teeth, wherein the teeth of the first pawl and the teeth of the second pawl are engageable with the spline teeth, and wherein the teeth of the first pawl or the second pawl advance circumferentially about the drive by two or more spline teeth as a result of one revolution of the crankshaft.

15. The ratchet tool of claim 11, wherein the drive defines an insertion hole configured to receive a coupling portion of an accessory, the accessory including an adapter portion extending from the coupling portion.

16. The ratchet tool of claim 15, wherein the adapter portion includes a recess configured to receive a fastener, the recess having a hexagonal shape.

17. The ratchet tool of claim 15, wherein the adapter portion includes a drive configured for coupling to a tool bit, the drive having a square shape.

18. The ratchet tool of claim 15, wherein the coupling portion includes a through hole.

19. The ratchet tool of claim 11, wherein the yoke housing includes an upper flange and a lower flange, the upper flange and the lower flange defining a tool height therebetween,
wherein the ratchet tool further comprises an accessory removably coupled to the drive, the accessory having a coupling portion configured to project beyond the upper flange when the accessory is inserted into the drive in a first direction, the ratchet tool and the accessory defining a total height when the accessory is coupled to the tool,
wherein the accessory is insertable into an opposite side of the drive in a second direction such that the coupling portion projects beyond the lower flange when the accessory is inserted into the drive in the second direction, and
wherein a ratio of the total height to the tool height is greater than 1.75:1.

20. A ratchet tool comprising:
a housing including a drive housing in which a motor is supported and a yoke housing extending from the drive housing;
a crankshaft coupled to the motor and rotatable therewith about a crankshaft axis, the crankshaft at least partially supported in the yoke housing and including a coupling portion having a coupling axis radially offset from the crankshaft axis;
a ratchet assembly pivotally coupled to the yoke housing and operably engaged to the coupling portion, the ratchet assembly including
a yoke,
a pawl pivotably coupled to the yoke such that the pawl is pivotable about a pawl axis, and
a drive rotatably supported in the yoke such that the drive is rotatable about a drive axis, the drive including a fastening hole defining a circumscribed circle having a diameter of less than 16.5 millimeters,
wherein a distance between the pawl axis and the fastening axis is as least 25 millimeters.
